(19) United States
(12) Patent Application Publication
(10) Pub. No.: US 2023/0150829 A1
(43) Pub. Date: May 18, 2023

(54) LITHIUM ION CONDUCTING SOLID MATERIALS

(71) Applicants: BASF SE, Ludwigshafen am Rhein (DE); UNIVERSITY OF WATERLOO, Waterloo (CA)

(72) Inventors: Parvin Adeli, Waterloo (CA); Zhang Zhizhen, Waterloo (CA); Linda Nazar, Waterloo (CA); Joern Kulisch, Ludwigshafen (DE); Xiaohan Wu, Ludwigshafen (DE)

(21) Appl. No.: 17/917,336

(22) PCT Filed: Apr. 8, 2021
(86) PCT No.: PCT/EP2021/059132

§ 371 Date: Oct. 6, 2022

(30) Foreign Application Priority Data
Apr. 9, 2020 (WO) 20169037.7

(51) Int. Cl. C01D 15/04

(52) U.S. Cl. CPC C01D 15/04; C01P 2006/40

(57) ABSTRACT

Described are a solid material which has ionic conductivity for lithium ions, a process for preparing said solid material, a use of said solid material as a solid electrolyte for an electrochemical cell, a solid structure selected from the group consisting of a cathode, an anode and a separator for an electrochemical cell comprising the solid material, and an electrochemical cell comprising such solid structure.

Described are a solid material which has ionic conductivity for lithium ions, a process for preparing said solid material, a use of said solid material as a solid electrolyte for an electrochemical cell, a solid structure selected from the group consisting of a cathode, an anode and a separator for an electrochemical cell comprising the solid material, and an electrochemical cell comprising such solid structure.

Due to the wide-spread use of all solid state lithium batteries, there is an increasing demand for solid state electrolytes having a high conductivity for lithium ions. An important class of such solid electrolytes are lithium argyrodites.

U.S. Pat. No. 8,075,865 B2 discloses lithium argyrodites of formula (*)

Li₍₁₂₋ₙ₋ₓ₎Bⁿ⁺X²⁻₆₋ₓY⁻ₓ (*)

wherein

B is selected from the group consisting of P, As, Ge, Ga, Sb, Si, Sn, Al, In, Ti, V, Nb, and Ta,

X is selected from the group consisting of S, Se, and Te,

Y is selected from the group consisting of Cl, Br, I, F, CN, OCN, SCN, and N₃, and 0≤x≤2. For the specific compound Li₆PS₅I an ionic conductivity of about 7*10⁻³ S/cm is reported in U.S. Pat. No. 8,075,865 B2.

For the sake of improving ionic conductivity and/or chemical stability, a couple of further modifications of lithium argyrodites has been studied, including partial substitution of lithium by other metals. For instance, EP 3 407 412 A1 discloses an article for use in an electro-chemical cell, comprising a compound of formula (**):

LiₓM_{y}Q_{w}P_{z}SᵤXₜ (I)

wherein:

M is selected from the group consisting of Na, K, Fe, Mg, Ag, Cu, Zr, and Zn,

Q is absent or is selected from the group consisting of Cr, B, Sn, Ge, Si, Zr, Ta, Nb, V, P, Fe, Ga, Al, As, and combinations thereof, and wherein Q, when present, is different than M,

X is absent or is selected from the group consisting of halide and pseudohalide,

x is 8-22, y is 0.1-3, w is 0-3, z is 0.1-3, u is 7-20, and t is 0-8.

There is an ongoing need for lithium ion conductors which exhibit suitable ionic conductivity for application as solid electrolyte in an all-solid state lithium battery as well as electrochemical stability versus lithium metal.

It is an objective of the present disclosure to provide a solid material which may be used as a solid electrolyte for an electrochemical cell. In addition, there is provided a process for preparing said solid material, a use of said solid material as a solid electrolyte for an electrochemical cell, a solid structure selected from the group consisting of a cathode, an anode and a separator for an electrochemical cell comprising the solid material, and an electrochemical cell comprising such solid structure, wherein said solid structure comprises said solid material.

According to a first aspect, there is provided a solid material having a composition according to general formula (I)

Li_{6+2*n-x-m*y}M_{y}PS₅₊ₙ₋ₓX₁₊ₓ (I)

wherein

M is one or more selected from the group consisting of divalent metals Mg, Ca, Sr, Ba and Zn, and trivalent metals Sc, La, Al and Ga;

X is one or more selected from the group consisting of F, Cl, Br and I;

0≤x≤0.8, preferably 0.15≤x≤0.6;

0.01≤y≤0.25,preferably 0.05≤y≤0.2, more preferably 0.05≤y≤0.15;

0≤n≤0.05;

m is 2 when M is a divalent metal and m is 3 when M is a trivalent metal.

A solid material according to the above-defined first aspect may have a composition according to general formula (I) wherein 0.15≤x≤0.6.

A solid material according to the above-defined first aspect may have a composition according to general formula (I) wherein 0.05≤y≤0.2, preferably 0.05≤y≤0.15.

Especially, a solid material according to the above-defined first aspect may have a composition according to general formula (I) wherein 0.15≤x≤0.6 and 0.05≤y≤0.2. Further specifically, a solid material according to the above-defined first aspect may have a composition according to general formula (I) wherein 0.15≤x≤0.6 and 0.05≤y≤0.15.

Surprisingly it has been found that solid materials as defined above may exhibit favorable lithium ion conductivity as well as electrochemical stability versus lithium metal. Without wishing to be bound by any theory, it is assumed that due to the presence of the divalent resp. trivalent metal M in the solid material having a composition according to general formula (I) lithium vacancies are generated which results in an increase of the mobility and diffusivity of lithium ions.

A solid material according to the above-defined first aspect may be crystalline as detectable by the X-ray diffraction technique. A solid material is referred to as crystalline when it exhibits a long range order that is characteristic of a crystal, as indicated by the presence of clearly defined reflections in its X-ray diffraction pattern. In this context, a reflection is considered as clearly defined if its intensity is more than 10% above the background.

A solid material according to the above-defined first aspect may consist of a single phase or of more than one phase, e.g. a main phase (primary phase) and minor amounts of impurities and secondary phases. It is understood that formula (I) is an empirical formula (gross formula) as determinable by means of elemental analysis. Accordingly, formula (I) defines a composition which is averaged over all phases present in the solid material. However, a solid material according to the above-defined first aspect comprises at least one phase which as such has a composition according to formula (I). In case a crystalline solid material according to the above-defined first aspect contains more than one phase, then the weight fraction of phases which as such do not have a composition according to formula (I) (e.g. impurity phases, secondary phases) is so small that the composition averaged over all phases is according to formula (I). The total weight fraction of secondary phases and impurity phases may be 20% or less, preferably 10% or less, further preferably 5% or less, most preferably 3% or less, based on the total weight of the solid material. If present, the secondary phases and impurity phases mainly consist of the precursors used for preparing the solid material, e.g. LiX (wherein X is as defined above) and Li₂S, and sometimes impurity phases which may originate from impurities of the precursors or from products formed by side reactions of the precursors (e.g. Li₃PS₄ and CaP₄O₁₁). For details of preparing a solid material according to the above defined first aspect, see the information provided below in the context of the second aspect of this disclosure.

In certain cases, a solid material according to the above-defined first aspect is in the form of a polycrystalline powder, or in the form of single crystals.

A crystalline solid material according to the above-defined first aspect may have an argyrodite structure characterized by the cubic space group F-43m. The argyrodite structure is determined by powder X-ray diffraction (XRD) measurements as generally known in the art. Details are described in the examples section.

In a solid material of general formula (I) the molar ratio between the total of elements X and P is defined as X/P=a. In a solid material of general formula (I), for the molar ratio X/P=a the following condition is satisfied: 1≤a≤1.8. In certain cases, for the molar ratio X/P=a the following condition is satisfied preferably 1.45≤a≤1.6.

In a solid material of general formula (I) the molar ratio between Li and P is defined as Li/P=b. In a solid material of general formula (I), for the molar ratio Li/P=b the following condition is satisfied: 4.05≤b<6.08.

In a solid material of general formula (I) the molar ratio between the total of metals M and P is defined as M/P=c. In a solid material of general formula (I), for the molar ratio M/P=c the following condition is satisfied: 0.01≤c≤0.25. In certain cases, for the molar ratio M/P=c the following condition is satisfied 0.01≤c≤0.15. In certain cases, for the molar ratio M/P=c the following condition is satisfied 0.01≤c≤0.12.

In certain cases, for the molar ratio X/P=a the following condition is satisfied: 1.45≤a≤1.6; and for the molar ratio M/P=c the following condition is satisfied: 0.01≤c≤0.15. In certain cases, for the molar ratio X/P=a the following condition is satisfied: 1.45≤a≤1.6; and for the molar ratio M/P=c the following condition is satisfied: 0.01≤c≤0.12.

Surprisingly it has been found that adjusting the molar ratio between the total of elements X and the total of metals M, X/M=a/c, may have a favorable influence on the ionic conductivity. In this regard solid materials of general formula (I) are preferred wherein 14≤a/c≤16, more preferably 15.30≤a/c≤15.55.

A solid material according to the above-defined first aspect may have an ionic conductivity of 1 mS/cm or more, in some cases 3 mS/cm or more, in further specific cases 6 mS/cm or more, in each case at a temperature of 25° C. The ionic conductivity is determined in the usual manner known in the field of battery materials development by means of electrochemical impedance spectroscopy in a blocking electrode configuration (for details see examples section below).

At the same time, a solid material according to the above-defined first aspect may have an almost negligible electronic conductivity. More specifically the electronic conductivity may be at least 3 orders of magnitude lower than the ionic conductivity, preferably at least 5 orders of magnitude lower than the ionic conductivity. In certain cases, a solid material according to the above-defined first aspect exhibits an electronic conductivity of 10⁻⁹ S/cm or less or even of 10⁻¹⁰ S/cm or less. The electronic conductivity is determined in the usual manner known in the field of battery materials development by means of direct-current (DC) polarization measurements at different voltages.

A solid material according to the above-defined first aspect may have a composition according to general formula (I) wherein X is Cl (chlorine), i.e. a composition according to general formula (Ia)

Li_{6+2-n-x-m*y}M_{y}PS₅₊ₙ₋ₓCl₁₊ₓ (Ia)

wherein M, m, n, x and y have the same meaning as defined above for general formula (I).

A solid material according to the above-defined first aspect may have a composition according to general formula (Ia) wherein 0.15≤x≤0.6.

A solid material according to the above-defined first aspect may have a composition according to general formula (Ia) wherein 0.05≤y≤0.2, preferably 0.05≤y≤0.15.

More specifically, a solid material according to the above-defined first aspect may have a composition according to general formula (Ia) wherein 0.15≤x≤0.6 and 0.05≤y≤0.2. Still more specifically, a solid material according to the above-defined first aspect may have a composition according to general formula (Ia) wherein 0.15≤x≤0.6 and 0.05≤y≤0.15.

A first group of specific solid materials according to the above-defined first aspect consists of solid materials having a composition according to general formula (I) wherein M is one or more selected from the group consisting of Mg, Ca, Sr, Ba and Zn (i.e. divalent metals), so that m is 2. Thus, a solid material of said first group has a composition according to general formula (Ib)

Li_{6+2*n-x-2*y}M_{y}PS₅₊ₙ₋ₓX₁₊ₓ (Ib)

wherein M, X, n, x and y have the same meaning as defined above for general formula (I).

A solid material of said first group may have a composition according to general formula (Ib) wherein 0.15≤x≤0.6.

A solid material of said first group may have a composition according to general formula (Ib) wherein 0.01≤y≤0.2, preferably 0.05≤y≤0.15.

A solid material of said first group may have a composition according to general formula (Ib) wherein n=0 or n=0.05.

A solid material of said first group may have a composition according to general formula (Ib) wherein X is Cl.

Especially, a solid material of said first group may have a composition according to general formula (Ib) wherein 0.15≤x≤0.6. 0.01≤y≤0.2; and X is Cl. Further specifically, a solid material of said first group may have a composition according to general formula (Ib) wherein 0.15≤x≤0.6, 0.05≤y≤0.15; and X is Cl.

A solid material of said first group may have a composition according to general formula (Ib) wherein M is Ca.

Especially, a solid material of said first group may have a composition according to general formula (Ib) wherein 0.15≤x≤0.6, 0.01≤y≤0.2; and M is Ca. Further specifically, a solid material of said first group may have a composition according to general formula (Ib) wherein 0.15≤x≤0.6, 0.05≤y≤0.15; and M is Ca.

A solid material of said first group may have a composition according to general formula (Ib) wherein M is Ca and X is Cl.

Especially, a solid material of said first group may have a composition according to general formula (Ib) wherein 0.15≤x≤0.6, 0.01≤y≤0.2; M is Ca and X is Cl. Further specifically, a solid material of said first group may have a composition according to general formula (Ib) wherein 0.15≤x≤0.6, 0.05≤y≤0.15; M is Ca and X is Cl.

A solid material of said first group may have a composition according to general formula (Ib) wherein 0.15≤x≤0.6, 0.01≤y≤0.2; n=0, M is Ca and X is Cl. Further specifically, a solid material of said first group may have a composition according to general formula (Ib) wherein 0.15≤x≤0.6, 0.05≤y≤0.15; n=0, M is Ca and X is Cl.

A solid material of said first group may have a composition according to general formula (Ib) wherein 0.15 ≤x≤0.6, 0.01≤y≤0.2; n=0.05, M is Ca and X is Cl. Further specifically, a solid material of said first group have a composition according to general formula (Ib) wherein 0.15≤x≤0.6, 0.05≤y≤0.15; n=0.05; M is Ca and X is Cl.

A second group of specific solid materials according to the above-defined first aspect consists of solid materials having a composition according to general formula (I) wherein M is one or more selected from the group consisting of Sc, La, Al and Ga (i.e. trivalent metals), so that m is 3. Thus, a solid material of said second group has a composition according to general formula (Ic)

Li_{6+2*n-x-3*y}M_{y}PS₅₊ₙ₋ₓX₁₊ₓ (Ic)

wherein M, X, n, x and y have the same meaning as defined above for general formula (I).

A solid material of said second group may have a composition according to general formula (Ic) wherein 0.15≤x≤0.6.

A solid material of said second group may have a composition according to general formula (Ic) wherein 0.01≤y≤0.15, preferably 0.05≤y≤0.15.

A solid material of said second group may have a composition according to general formula (Ic) wherein n=0.

A solid material of said second group may have a composition according to general formula (Ic) wherein X is Cl.

Especially, a solid material of said second group may have a composition according to general formula (Ic) wherein 0.15≤x≤0.6, 0.01≤y≤0.15; and X is Cl. Further specifically, a solid material of said second group may have a composition according to general formula (Ic) wherein 0.15≤x≤0.6, 0.05≤y≤0.15; and X is Cl.

A solid material of said second group may have a composition according to general formula (Ic) wherein M is Al or M is Ga.

Especially, a solid material of said second group may have a composition according to general formula (Ic) wherein 0.15≤x≤0.6, 0.01≤y≤0.15; and M is Al or Ga. Further specifically, a solid material of said second group may have a composition according to general formula (Ic) wherein 0.15≤x≤0.6, 0.05≤y≤0.15; and M is Al or Ga.

A solid material of said second group may have a composition according to general formula (Ic) wherein M is Al and X is Cl.

A solid material of said second group may have a composition according to general formula (Ic) wherein M is Ga and X is Cl.

Especially, a solid material of said second group may have a composition according to general formula (Ic) wherein 0.15≤x≤0.6, 0.01≤y≤0.15; M is Al and X is Cl. Further specifically, a solid material of said second group may have a composition according to general formula (Ic) wherein 0.15≤x≤0.6, 0.05≤y≤0.15; M is Al and X is Cl.

Especially, a solid material of said second group may have a composition according to general formula (Ic) wherein 0.15≤x≤0.6, 0.01≤y≤0.15; M is Ga and X is Cl. Further specifically, a solid material of said second group may have a composition according to general formula (Ic) wherein 0.15≤x≤0.6, 0.05≤y≤0.15; M is Ga and X is Cl.

A solid material of said second group may have a composition according to general formula (Ic) wherein 0.15≤x≤0.6, 0.01≤y≤0.15; n=0, M is Al and X is Cl. Further specifically, a solid material of said second group may have a composition according to general formula (Ic) wherein 0.15≤x≤0.6, 0.05≤y≤0.15; M is Al and X is Cl.

A solid material of said second group may have a composition according to general formula (Ic) wherein 0.15≤x≤0.6, 0.01≤y≤0.15; n=0, M is Ga and X is Cl. Further specifically, a solid material of said second group may have a composition according to general formula (Ic) wherein 0.15≤x≤0.6, 0.05≤y≤0.15; M is Ga and X is Cl.

Preferred solid materials according to the first aspect as defined above are those having one or more of the specific features disclosed above.

According to a second aspect, there is provided a process for obtaining a solid material according to the above-defined first aspect. Said process comprises the following steps:
a) preparing or providing a reaction mixture comprising the precursors
   (1) Li₂S,
      and/or
      Li and S in elemental form;
   (2) one or more sulfides of phosphorus;
   (3) one or more compounds LiX wherein X is selected from the group consisting of F, Cl, Br and I;
   (4) one or more sulfides of metals M selected from the group consisting of divalent metals Mg, Ca, Sr, Ba and Zn, and trivalent metals Sc, La, Al and Ga
      and/or
      S in elemental form as well as one or more metals M selected from the group consisting of divalent metals Mg, Ca, Sr, Ba and Zn, and trivalent metals Sc, La, Al and Ga, in each case in elemental form;
   (5) optionally one or more halides MXₘ, wherein X is selected from the group consisting of F, Cl, Br and I; M is selected from the group consisting of divalent metals Mg, Ca, Sr, Ba and Zn, and trivalent metals Sc, La, Al and Ga; and m is 2 when M is a divalent metal and m is 3 when M is a trivalent metal;
   wherein in said reaction mixture the molar ratio of the elements Li, M, P, S and X matches general formula (I);
b) heat-treating the reaction mixture in a temperature range of from 500° C. to 800° C. for a total duration of from 3 hours to 350 hours so that a reaction product is formed, and cooling the obtained reaction product so that a solid material having a composition according to general formula (I) is obtained.

In step a) of the process according to the above-defined second aspect, a reaction mixture comprising precursors for the reaction product to be formed in step b) is provided. Said precursors are
(1) Li₂S,
   and/or
   both of Li and S in elemental form;
(2) one or more sulfides of phosphorus;
(3) one or more compounds LiX wherein X is selected from the group consisting of F, Cl, Br and I;
(4) one or more sulfides of metals M selected from the group consisting of divalent metals Mg, Ca, Sr, Ba and Zn, and trivalent metals Sc, La, Al and Ga
   and/or
   S in elemental form as well as one or more metals M selected from the group consisting of divalent metals Mg, Ca, Sr, Ba and Zn, and trivalent metals Sc, La, Al and Ga, in each case in elemental form;

wherein in said reaction mixture the molar ratio of the elements Li, M, P, S and X matches general formula (I).

In certain cases, the reaction mixture comprises the above-defined precursors (1), (2), (3) and (4), and further comprises
(5) optionally one or more halides MXₘ, wherein X is selected from the group consisting of F, Cl, Br and I; M is selected from the group consisting of divalent metals Mg, Ca, Sr, Ba and Zn, and trivalent metals Sc, La, Al and Ga; and m is 2 when M is a divalent metal and m is 3 when M is a trivalent metal,

wherein in said reaction mixture the molar ratio of the elements Li, M, P, S and X matches general formula (I).

Preferably, the reaction mixture consists of the above-defined precursors (1), (2), (3) and (4) resp. (1), (2), (3), (4) and (5).

In each of precursors (3) and (5), X may be selected independently. Preferably, in each of precursors (3) and (5), X is the same, preferably Cl. A reaction mixture wherein X in all precursors (3) and (5) is CI is suitable for preparing a solid material having a composition according to general formula (Ia) as defined above.

Precursor (1) may be provided in the form of Li₂S, and/or both of Li (lithium) and S (sulfur) may be provided in elemental form. Preferably, precursor (1) is Li₂S.

Preferably precursor (2) is P₂S₅.

Preferably, precursor (3) is LiCl.

Precursor (4) may be provided in the form of one or more sulfides of metals M selected from the group consisting of divalent metals Mg, Ca, Sr, Ba and Zn, and trivalent metals Sc, La, Al and Ga; and/or S (sulfur) as well as one or more metals M selected from the group consisting of divalent metals Mg, Ca, Sr, Ba and Zn, and trivalent metals Sc, La, Al and Ga may be provided in elemental form. Preferably, precursor (4) is in the form of one or more sulfides of metals M selected from the group consisting of divalent metals Mg, Ca, Sr, Ba and Zn, and trivalent metals Sc, La, Al and Ga.

In the reaction mixture provided in step a), for the molar ratio between the total of elements X and P which is defined as X/P=a, the following condition is satisfied: 1≤a≤1.8. In certain specific cases, the following condition is satisfied: 1.45≤a≤1.6.

In the reaction mixture provided in step a), for the molar ratio between Li and P which is defined as Li/P=b, the following condition is satisfied: 4.05≤b<6.08.

In the reaction mixture provided in step a), for the molar ratio between the total of metals M and P which is defined as M/P=c, the following condition is satisfied: 0.01≤c≤0.25. In certain specific cases, the following condition is satisfied: 0.01≤c≤0.15. In certain specific cases, the following condition is satisfied: 0.01≤c≤0.12.

In certain more specific cases, in the reaction mixture provided in step a) for the molar ratio X/P=a the following condition is satisfied: 1.45≤a≤1.6; and for the molar ratio M/P=c the following condition is satisfied: 0.01≤c≤0.15.

In certain more specific cases, in the reaction mixture provided in step a) for the molar ratio X/P=a the following condition is satisfied: 1.45≤a≤1.6; and for the molar ratio M/P=c the following condition is satisfied: 0.01≤c≤0.12.

In the reaction mixture provided in step a), for the molar ratio between the total of elements X and the total of metals M, which is defined as X/M=a/c the following condition may be satisfied: 14≤a/c≤16, more preferably 15.30≤a/c≤15.55.

In certain processes according to the above-defined second aspect, the precursor (4) is one or more sulfides of metals M selected from the group consisting of divalent metals Mg, Ca, Sr, Ba and Zn, and/or S (sulfur) in elemental form as well as one or more metals M selected from the group consisting of divalent metals Mg, Ca, Sr, Ba and Zn in elemental form; and precursor (5)—when present—is one or more halides MX₂ wherein X is selected from the group consisting of F, Cl, Br and I; and M is selected from the group consisting of divalent metals Mg, Ca, Sr, Ba and Zn. Such processes are suitable for preparing solid materials having a composition according to general formula (Ib) as defined above. Thus, a reaction mixture suitable for preparing a solid material having a composition according to general formula (Ib) comprises the precursors
(1) Li₂S,
   and/or
   Li and S in elemental form;
(2) one or more sulfides of phosphorus;
(3) one or more compounds LiX wherein X is selected from the group consisting of F, Cl, Br and I;
(4) one or more sulfides of metals M selected from the group consisting of divalent metals Mg, Ca, Sr, Ba and Zn,
   and/or
   S in elemental form as well as one or more metals M selected from the group consisting of divalent metals Mg, Ca, Sr, Ba and Zn in elemental form;
(5) optionally one or more halides MX₂ wherein X is selected from the group consisting of F, Cl, Br and I; M is selected from the group consisting of divalent metals Mg, Ca, Sr, Ba and Zn;

wherein in said reaction mixture the molar ratio of the elements Li, M, P, S and X matches general formula (Ib).

Preferably, the reaction mixture consists of the above-defined precursors (1), (2), (3) and (4) resp. (1), (2), (3), (4) and (5).

In each of precursors (3) and (5), X may be selected independently. Preferably, in each of precursors (3) and (5), X is the same, preferably Cl.

Precursor (1) may be provided in the form of Li₂S, and/or Li (lithium) and S (sulfur) may be provided in elemental form. Preferably, precursor (1) is Li₂S.

Preferably precursor (2) is P₂S₅.

Preferably, precursor (3) is LiCl.

Precursor (4) may be provided in the form of one or more sulfides of metals M selected from the group consisting of divalent metals Mg, Ca, Sr, Ba and Zn, and/or S (sulfur) as well as one or more metals M selected from the group consisting of divalent metals Mg, Ca, Sr, Ba and Zn may be provided in elemental form. Preferably, precursor (4) is in the form of one or more sulfides of metals M selected from the group consisting of divalent metals Mg, Ca, Sr, Ba and Zn.

In certain cases, M is Ca. In such cases precursor (4) is preferably CaS, and precursor (5) may be omitted.

Thus, a reaction mixture suitable for preparing a solid material having a composition according to general formula (Ib) may consist of the precursors
(1) Li₂S
(2) P₂S5
(3) LiCl
(4) CaS

wherein in said reaction mixture the molar ratio of the elements Li, Ca, P, S and X matches general formula (Ib).

In certain other processes according to the above-defined second aspect, the precursor (4) is one or more sulfides of metals M selected from the group consisting of trivalent metals, Sc, La, Al and Ga and/or S (sulfur) in elemental form as well as one or more metals M selected from the group consisting of trivalent metals Sc, La, Al and Ga in elemental form; and precursor (5)—when present—is one or more halides MX₃, wherein X is selected from the group consisting of F, Cl, Br and I; and M is selected from the group consisting of trivalent metals Sc, La, Al and Ga. Such processes are suitable for preparing solid materials having a composition according to general formula (Ic) as defined above.

Thus, a reaction mixture suitable for preparing a solid material having a composition according to general formula (Ic) comprises the precursors
(1) Li₂S,
   and/or
   Li and S in elemental form;
(2) one or more sulfides of phosphorus;
(3) one or more compounds LiX wherein X is selected from the group consisting of F, Cl, Br and I;
(4) one or more sulfides of metals M selected from the group consisting of trivalent metals Sc, La, Al and Ga,
   and/or
   S in elemental form as well as one or more metals M selected from the group consisting of trivalent metals Sc, La, Al and Ga in elemental form;
(5) optionally one or more halides MX3, wherein X is selected from the group consisting of F, Cl, Br and I; M is selected from the group consisting of trivalent metals Sc, La, Al and Ga;

wherein in said reaction mixture the molar ratio of the elements Li, M, P, S and X matches general formula (Ic).

Preferably, the reaction mixture consists of the above-defined precursors (1), (2), (3) and (4) resp. (1), (2), (3), (4) and (5).

In each of precursors (3) and (5), X may be selected independently. Preferably, in each of precursors (3) and (5), X is the same, preferably Cl. Preferably, precursor (3) is LiCl.

Precursor (1) may be provided in the form of Li₂S, and/or Li (lithium) and S (sulfur) may be provided in elemental form. Preferably, precursor (1) is Li₂S.

Preferably precursor (2) is P₂S₅.

Preferably, precursor (3) is LiCl.

Precursor (4) may be provided in the form of one or more sulfides of metals M selected from the group consisting of trivalent metals Sc, La, Al and Ga, and/or S (sulfur) as well as one or more metals M selected from the group consisting of trivalent metals Sc, La, Al and Ga may be provided in elemental form. Preferably, precursor (4) is in the form of one or more sulfides of metals M selected from the group consisting of trivalent metals Sc, La, Al and Ga.

In certain cases, M is Ga or Al. In such cases precursor (4) is preferably A1253 resp. Ga2S3, and precursor (5) may be omitted.

Thus, a reaction mixture suitable for preparing a solid material having a composition according to general formula (Ic) may consist of the precursors
(1) Li₂S
(2) P₂S₅
(3) LiCl
(4) Al₂S₃ resp. Ga₂S₃.

wherein in said reaction mixture the molar ratio of the elements Li, P, S, X and Al resp. Ga matches general formula (Ic).

In step a) the reaction mixture may be obtained by mixing the precursors. Mixing the precursors may be performed by means of grinding the precursors together. Grinding can be done using any suitable means.

The reaction mixture which is prepared or provided in step a) may be in the form of a powder, or in the form of pellets. For instance, the reaction mixture which is prepared or provided in step a) may be formed into pellets, which are heat-treated in step b). Then, a solid material in the form of pellets or chunks is obtained, which may be ground into powder for further processing.

It is useful that in step a) any handling is performed under a protective gas atmosphere.

In step b) of the process according to the above-defined second aspect, the reaction mixture is allowed to react so that a solid material having a composition according to general formula (I) is obtained. In other words, in step b) the precursors in the reaction mixture react with each other to obtain a solid material having a composition according to general formula (I).

The reaction mixture prepared or provided in step a) is heat-treated in step b) to enable the reaction of the precursors. Heat-treating may be performed in a closed vessel. The closed vessel may be a sealed quartz tube or any other type of container which is capable of withstanding the temperature of the thermal treatment and is not subject to reaction with any of the precursors, such as a glassy carbon crucible or a tantalum crucible.

In step b) the reaction mixture may be heat-treated in a temperature range of from 500° C. to 800° C. for a total duration of 3 hours to 350 hours so that a reaction product is formed. More specifically, in step b) the reaction mixture may be heat-treated in a temperature range of from 500° C. to 600° C. for a total duration of 4 hours to 9 hours.

When the duration of the heat treatment of step b) is completed, the formed reaction product is allowed to cool down. Thus, a solid material having a composition according to general formula (I) is obtained. Cooling of the reaction product is preferably performed using a cooling rate of 0.5 to 10° C. per minute.

A specific process according to the second aspect as described herein comprises the steps
a) preparing or providing a solid reaction mixture comprising the precursors (1), (2), (3), (4) and optionally (5) as defined above, preferably a reaction mixture consisting of the precursors (1), (2), (3), (4) and optionally (5) as defined above
b) heat-treating the reaction mixture in a temperature range of 500° C. to 800° C. for a total duration of 3 hours to 350 hours so that a reaction product is formed, and cooling the obtained reaction product so that a solid material having a composition according to general formula (I) is obtained.

It is noteworthy that a solid material prepared as described above exhibits high ionic conductivity so that further annealing to cure structural defects is not necessary. This is an important advantage because it enables the solid material to be employed as electrolyte for an all-solid-state battery in the form of cold-pressed pellets.

Preferred processes according to the second aspect as defined herein are those having one or more of the specific features disclosed above.

A solid material according to the above-defined first aspect resp. obtained by the process according to the above-defined second aspect can be used as a solid electrolyte for an electrochemical cell. Herein the solid electrolyte may form a component of a solid structure for an electrochemical cell, wherein said solid structure is selected from the group consisting of cathode, anode and separator. Accordingly, a solid material according to the above-defined first aspect resp. obtained by the process according to the above-defined second aspect can be used (if necessary in combination with additional components) for producing a solid structure for an electrochemical cell, such as a cathode, an anode or a separator.

Thus, the present disclosure further provides the use of a solid material according to the above-defined first aspect resp. obtained by the process according to the above-defined second aspect as a solid electrolyte for an electrochemical cell. Herein, the solid material according to the above-defined first aspect resp. obtained by the process according to the above-defined second aspect may have a composition according to formula (Ia) as defined above resp. according to formula (Ib) or to formula (Ic) as defined above. Regarding specific and preferred solid materials according to the above-defined first aspect resp. obtained by the process according to the above-defined second aspect, the same applies as disclosed above in the context of the first aspect.

More specifically, the present disclosure further provides the use of a solid material according to the above-defined first aspect resp. obtained by the process according to the above-defined second aspect as a component of a solid structure for an electrochemical cell, wherein said solid structure is selected from the group consisting of cathode, anode and separator.

In the context of the present disclosure, the electrode where during discharging a net negative charge occurs is called the anode and the electrode where during discharging a net positive charge occurs is called the cathode. Suitable electrochemically active cathode materials and suitable electrochemically active anode materials are known in the art. The cathode of an all-solid-state electrochemical cell usually comprises beside an active cathode material as a further component a solid electrolyte. Also the anode of an all-solid-state electrochemical cell usually comprises a solid electrolyte as a further component beside an active anode material. Said solid electrolyte may be a solid material according to the above-defined first aspect resp. obtained by the process according to the above-defined second aspect.

In an electrochemical cell, a separator electronically separates a cathode and an anode from each other. In an all solid state electrochemical cell, the separator comprises a solid electrolyte. Said solid electrolyte may be a solid material according to the above-defined first aspect resp. obtained by the process according to the above-defined second aspect.

The present disclosure further provides a solid structure for an electrochemical cell, wherein the solid structure is selected from the group consisting of cathode, anode and separator, wherein the solid structure for an electrochemical cell comprises a solid material according to the above-defined first aspect resp. obtained by the process according to the above-defined second aspect. Herein, the solid material according to the above-defined first aspect resp. obtained by the process according to the above-defined second aspect may have a composition according to formula (Ia) as defined above resp. according to formula (Ib) or formula (Ic) as defined above.

The form of the solid structure for an electrochemical cell, in particular for an all-solid-state lithium battery, depends in particular on the form of the electrochemical cell itself.

The present disclosure further provides a solid structure for an electrochemical cell, wherein the solid structure is selected from the group consisting of cathode, anode and separator, wherein the solid structure for an electrochemical cell comprises a solid material according to the above-defined first aspect resp. obtained by the process according to the above-defined second aspect. More specifically, there is provided a solid structure as defined above wherein in certain preferred cases a solid material according to the above-defined first aspect resp. obtained by the process according to the above-defined second aspect is in direct contact with lithium metal.

The present disclosure further provides an electrochemical cell comprising a solid material according to the above-defined first aspect resp. obtained by the process according to the above-defined second aspect. In said electrochemical cell, the solid material according to the above-defined first aspect resp. obtained by the process according to the above-defined second aspect may form a component of one or more solid structures selected from the group consisting of cathode, anode and separator. More specifically, there is provided an electrochemical cell as defined above wherein in certain preferred cases a solid material according to the above-defined first aspect resp. obtained by the process according to the above-defined second aspect may be in direct contact with lithium metal.

The above-defined electrochemical cell may be a rechargeable electrochemical cell comprising the following constituents
α) at least one anode,
γ) at least one cathode,
γ) at least one separator,

wherein at least one of the three constituents is a solid structure selected from the group consisting of cathode, anode and separator comprises a solid material according to the above-defined first aspect resp. obtained by the process according to the above-defined second aspect.

Suitable electrochemically active cathode materials and suitable electrochemically active anode materials are known in the art. In an electrochemical cell as described above the anode α) may comprise graphitic carbon, metallic lithium or a metal alloy comprising lithium as the anode active material. Due to its superior electrochemical stability in direct contact with lithium metal, in certain preferred cases in a solid structure as defined above a solid material according to the above-defined first aspect resp. obtained by the process according to the above-defined second aspect may be in direct contact with an anode comprising lithium metal, so that no protecting layer is needed between them.

Electrochemical cells as described above may be alkali metal containing cells, especially lithium-ion containing cells. In lithium-ion containing cells, the charge transport is effected by Li⁺ ions.

The electrochemical cell may have a disc-like or a prismatic shape. The electrochemical cells can include a housing that can be from steel or aluminum.

A plurality of electrochemical cells as described above may be combined to an all solid-state battery, which has both solid electrodes and solid electrolytes. A further aspect of the present disclosure refers to batteries, more specifically to an alkali metal ion battery, in particular to a lithium ion battery comprising at least one electrochemical cell as described above, for example two or more electrochemical cells as described above. Electrochemical cells as described above can be combined with one another in alkali metal ion batteries, for example in series connection or in parallel connection. Series connection is preferred.

The electrochemical cells resp. batteries described herein can be used for making or operating cars, computers, personal digital assistants, mobile telephones, watches, camcorders, digital cameras, thermometers, calculators, laptop BIOS, communication equipment or remote car locks, and stationary applications such as energy storage devices for power plants. A further aspect of this disclosure is a method of making or operating cars, computers, personal digital assistants, mobile telephones, watches, camcorders, digital cameras, thermometers, calculators, laptop BIOS, communication equipment, remote car locks, and stationary applications such as energy storage devices for power plants by employing at least one inventive battery or at least one inventive electrochemical cell.

A further aspect of the present disclosure is the use of the electrochemical cell as described above in motor vehicles, bicycles operated by electric motor, robots, aircraft (for example unmanned aerial vehicles including drones), ships or stationary energy stores.

The present disclosure further provides a device comprising at least one inventive electrochemical cell as described above. Preferred are mobile devices such as are vehicles, for example automobiles, bicycles, aircraft, or water vehicles such as boats or ships. Other examples of mobile devices are those which are portable, for example computers, especially laptops, telephones or electrical power tools, for example from the construction sector, especially drills, battery-driven screwdrivers or battery-driven tackers.

The invention is illustrated further by the following examples which are not limiting.

### EXAMPLES

1. Preparation of solid materials

Reaction mixtures consisting of the precursors
(1) Li₂S (Alfa Aesar, 99.9%),
(2) P₂S₅ (Sigma-Aldrich, 99%),
(3) LiCl anhydrous beads (Sigma-Aldrich, 99.9%),
(4) one of CaS (Alfa Aesar, 99%), Al₂S₃ (Sigma-Aldrich, 98%) and Ga₂S₃ (Alfa Aesar, 99.99%)

in the proportions to obtain the target compositions (target stoichiometries) indicated in table 1 resp. 2 were prepared by grinding the precursors in an agate mortar for 15 minutes in an argon filled glovebox (MBraun, O₂ and H₂O content below 1 ppm). The ground reaction mixture with a typical weight of 0.5 gram was pelletized in a die (13 mm diameter) at 2 metric tons. The resulting pellets were transferred into quartz ampules which were sealed under vacuum. Glassy carbon crucibles were used to avoid direct contact of the pellets with the quartz ampules. Before transferring the pellets into the quartz ampules, said quartz ampules (inner diameter of 13 mm and length of 8 cm) were preheated for one day at 300° C. to avoid traces of water meddling in the reaction. The heat treatment of the pelletized reaction mixture was carried out at 550° C. for 5 hours in a tube furnace with a heating rate of 0.5° C./min. Subsequently, each of the obtained solid materials was ground in an argon filled glovebox (MBraun, O₂ and H₂O content below 1 ppm), and loaded for XRD analysis into a 0.3 mm diameter quartz capillary which was sealed.

For comparison, Li₆PS₅Cl was obtained in the same manner except that the reaction mixture consisted of above-defined precursors (1)-(3) while precursor (4) was omitted.

2. Ionic and Electronic Conductivity

Electrochemical impedance spectroscopy (EIS) in blocking electrode configuration was employed to determine the ionic conductivities of the solid materials which were in the form of pellets. To obtain a pellet, a powder sample of the material was sandwiched between two stainless steel rods and cold-pressed at 2 tons (diameter of 10 mm) by a uniaxial hydraulic press. The thickness of the pellets obtained in this way (measured by an accurate digital caliper) ranged from 0.5 to 1.1 mm. EIS was carried out using a cell wherein the pellet is sandwiched between two metal foils which act as blocking electrodes. Impedance spectra were recorded with 100 mV amplitude in the frequency range of 1 MHz to 100 mHz at 298 K using a VMP3 potentiostat/galvanostat (Bio-logic).

For temperature dependent conductivity measurements, impedance spectra were recorded in the frequency range of 35 MHz to 100 mHz with MTZ-35 impedance analyzer (Bio-Logic) controlled by the MT-LAB (Bio-Logic) software from 298 K to 338 K at 5 K intervals.

Data analysis was performed using the EC-Lab software and the activation energy was determined from the slope of the Arrhenius plot.

Ionic conductivity of all materials (obtained from the fit of the real-axis impedance intercept in the Nyquist plot of the electrochemical impedance, average of two samples in each case) is given in tables 1 and 2 below. In table 1, activation energy (Ea) values obtained from impedance spectroscopy as explained above and from ⁷Li PFG-NMR (see below) at different temperatures are presented, too. For experimental details, see section 3.1 below. For detailed discussion, see section 5 below.

TABLE 1

| | | Eₐ (EIS) | Eₐ (PFG) |
|---|---|---|---|
| Material composition | σ/mS/cm | [eV] ± 0.01 | [eV] |
| Li₆PS₅Cl (comparison) | 3.12 | 0.34 | 0.35 |
| Li_{5.9}Ca_{0.05}PS₅Cl | 3.50 | — | — |
| Li_{5.8}Ca_{0.1}PS₅Cl | 4.26 | 0.35 | 0.34 |
| Li_{5.7}Ca_{0.15}PS₅Cl | 5.18 | 0.34 | 0.33 |
| Li_{5.6}Ca_{0.2}PS₅Cl | 3.40 | — | — |
| Li_{5.55}Ca_{0.1}PS_{4.75}Cl_{1.25} | 6.76 | 0.33 | 0.32 |
| Li_{5.45}Ca_{0.15}PS_{4.75}Cl_{1.25} | 6.06 | — | — |
| Li_{5.425}Ca_{0.1}PS_{4.625}Cl_{1.375} | 7.24 | 0.31 | 0.31 |
| Li_{5.3}Ca_{0.1}PS_{4.5}Cl_{1.5} | 7.74 | 0.31 | 0.30 |
| Li_{5.35}Ca_{0.1}PS_{4.5}Cl_{1.55} (pellet) | 10.2 | 0.3 | 0.29 |
| Li_{5.35}Ca_{0.1}PS_{4.5}Cl_{1.55} (powder) | | | 0.30 |

When x=0, increase of the Ca content y results in an increase of the ionic conductivity until y exceeds 0.15. At a Ca content of y=0.1, increase of the Cl content (x=0, 0.25, 0.375, 0.5, 0.55) results in a steady increase of the ionic conductivity. The same applies at a Ca content of y=0.15 when the chlorine content is increased from x=0 up to x=0.25, although materials having a Ca content y=0.15 exhibit a lower ionic conductivity than the corresponding materials having the same Cl content but a Ca content of y=0.1.

TABLE 2

| Material composition | σ/mS/cm |
|---|---|
| Li₆PS₅Cl (comparison) | 3.12 |
| Li_{5.7}Al_{0.1}PS₅Cl | 3.70 |
| Li_{5.4}Al_{0.2}PS₅Cl | 3.60 |
| Li_{5.45}Al_{0.1}PS_{4.75}Cl_{1.25} | 5.69 |
| Li_{5.15}Al_{0.2}PS_{4.75}Cl_{1.25} | 3.58 |
| Li_{5.85}Ga_{0.05}PS₅Cl | 3.74 |
| Li_{5.7}Ga_{0.1}PS₅Cl | 3.89 |
| Li_{5.4}Ga_{0.2}PS₅Cl | 4.05 |
| Li_{5.45}Ga_{0.1}PS_{4.75}Cl_{1.25} | 4.81 |

When x=0, increase of the content of Al resp. Ga from y=0 to y=0.1 results in an increase of the ionic conductivity, while further increase up to y=0.2 only for Ga results in a further increase of the ionic conductivity, but not for Al. At an Al content of y=0.1, increase of the Cl content (x=0, 0.15, 0.25, 0.35) results in an increase of the ionic conductivity until x exceeds 0.25. At a Ga content of y=0.1, increase of the Cl content so that x raises from x=0 to x=0.25, results in an increase of the ionic conductivity. When the Al content is y=0.2, increase of the Cl content so that x raises from x=0 to x=0.25 appears to have no significant influence on the ionic conductivity. Materials having an Al content of y=0.2 have a lower ionic conductivity than the corresponding materials having the same Cl content but an Al content of y=0.1.

Direct-current (DC) polarization curves at applied voltages of 0.25 V, 0.5 V and 0.75 V were recorded using the same cell configuration as applied for EIS for 15 to 20 minutes at each voltage at room temperature to determine the electronic conductivities of samples. The electronic conductivity was found to be 10⁻⁹ S*cm⁻¹ or lower.

3. Structural Analysis

3.1 Methods

The XRD patterns were measured overnight on an Empyrean X-ray diffractometer (PANalytical) with Cu kα radiation (1.5406 Å) while the samples were protected from air and moisture. The applied voltage and current were 45 kV and 40 mA, respectively, and the measurement range was 10 to 80 degrees. Patterns were recorded in Debye-Scherrer geometry, and HighScore Plus software was used to identify the peaks.

Raman spectra were collected on the pelletized samples using a Raman HORIBA HR800 spectrometer at an excitation of 514 nm. Prior to Raman measurements, all the samples were placed between two glass slides and sealed with epoxy in the glovebox.

Time-of-flight (TOF) neutron powder diffraction (NPD) data were collected at ambient temperature on POWGEN using 1.5 g of sample sealed in a vanadium can at the Spallation Neutron Source at the Oak Ridge National Laboratory (center λ: 1.5 Å, d-spacing over the range of 0.50097-13.0087 Å).

High-field, fast magic-angle-spinning (MAS) NMR was performed with a 1.9 mm probe on a Bruker 850 MHz HD spectrometer in a zirconia rotor, with ⁷Li possessing a 330 MHz Larmor frequency at the 20 T field strength. A 30 kHz MAS rate was employed for all samples, and a 3.5 μs, 110 W excitation pulse generated the spectra. ⁷Li referencing was nominally to 1M LiCl (aq), but it was found with previous studies (P. Adeli, J. D. Bazak, K. H. Park, I. Kochetkov, A. Huq, G. R. Goward, L. F. Nazar, Angew. Chem. Int. Ed. 2019, 58, 8681; Angew.Chem. 2019,131, 8773) that internally referencing to trace LiCl (s) impurity stemming from the argyrodite samples themselves was more reliable, absent a lock for the 1.9 mm probe and with the 850 MHz HD spectrometer being a pumped magnet system. To avoid saturation of this small LiCl (s) impurity signal, a 60 s recycle delay was utilized, with an 8-step phase cycle to remove any residual transmitter artifacts. Under static conditions at 7 Ton a Bruker Avance III 300WB spectrometer (vide infra, PFG-NMR methods), the spectra are already motionally narrowed and exhibit no satellite transitions, at all of the temperatures investigated, therefore the quadrupolar coupling for these materials is insufficient to generate a 2^{nd}-order quadrupole shift of the order of shift observed in the MAS spectra. 2D exchange spectroscopy (EXSY) was also performed for ⁷Li for certain materials (see below) which exhibited a secondary signal. A 12 ppm spectral width in the indirect dimension digitized with 650 points was used to acquire the 2D EXSY spectra, with a 4.5 s recycle delay and an 8-step phase cycle (using States-TPPI as the acquisition mode in the indirect dimension), which resulted in an approximately 7-hour experiment time (depending on mixing time) and was sufficient to eliminate any ringing in the indirect dimension. Mixing times ranged from 10 μs to 500 ms, but owing to the imbalance in spectral volumes between the primary and secondary signals, and the long tails of the primary signal, volumetric deconvolution of the cross-peaks was not reliable. Consequently, the results are only interpreted qualitatively to demonstrate that the secondary signal is in exchange with the primary signal Additionally, the secondary signals in the one-dimensional ⁷Li MAS spectra were deconvoluted using ssNake v1.0 (S. G. J. van Meerten, W. M. J. Franssen, A. P. M. Kentgens, J. Magn. Reson. 2019, 301, 56-66). Lorentzian lineshapes were used to fit both the primary and secondary peaks, but the primary peak was fit in isolation first and then the secondary peak was fit using the same line-broadening as determined for the first peak composition, a second Lorentzian was added and fit in conjunction with the primary Lorentzian to account for the full primary peak).

Fast MAS NMER for ³¹P was also conducted for certain samples, using a 1.9 mm zirconia rotor with 30 kHz MAS rate on the Bruker 850 MHz HD spectrometer (³¹P Larmor frequency of 343 MHz). A 6 μs excitation pulse at 80 W was used to observe the resonance, and a 60-second recycle delay was employed to avoid saturating the signal, established using inversion recovery experiments. A total of 64 scans were accumulated to achieve reasonable signal-to-noise, and signals were referenced to 85% H₃PO₄ in a capillary standard.

Diffusion measurements were conducted using the pulsed-field gradient (PFG) NMR technique (⁷Li Pulsed-Field Gradient NMR Spectroscopy), with a Bruker Avance III 300 MHz spectrometer (7.0 T; ⁷Li has a Larmor frequency of 117 MHz at this field strength) and a Diff50 gradient probe with a 5 mm ⁷Li coil insert. Samples were placed in a Shigemi tube with a packing depth of 3-4 mm in an Ar-filled glovebox, and the tube was sealed with parafilm. The sample plug in the Shigemi tube was aligned with the centre of the gradient coil using a standard ⁷Li frequency-encoding MRI. Temperature control was achieved with a BCU II gas chiller unit, over a targeted range of 268.2 K to 343.2 K. To determine the actual sample temperature, a δ ¹H shift thermometer calibration curve was developed for the same chiller gas settings as employed in the diffusion experiments using equivalent amounts of methanol (268.2 K to 303.2 K) and ethylene glycol (298.2 K to 343.2 K), and standard Bruker shift-difference parameters. It was also verified that gradient-related heating of the sample was negligible by repeating the chemical shift measurements immediately after transmitting the solid-state PFG experiment to the shift thermometer samples with the RF pulses blanked. Additionally, the temperature calibration takes into account the effect of only operating the water cooling bath for the gradient coils within the range of 283 K to 313 K (for thermal stability of the output). While performing variable-temperature PFG NMR experiments, temperatures were shifted in 10 K increments until the upper temperature range was reached, with 20 minutes of equilibration prior to commencing the experiment once the target temperature was achieved, and then cooled again in 10 K increments with a 5 K offset, to verify that there was no hysteresis in the data set (i.e. incomplete thermal equilibration). For the pellet and powder versions of Li_{5.35}Ca_{0.1}PS_{4.5}Cl_{1.55} samples (see section 5 below) samples, the nominal temperature range was 243.2 K to 358.2 K, with the methanol and ethylene glycol shift thermometers extended accordingly. The pellet was cold-pressed at 2 tons of applied pressure in a 10 mm dye to an approximate thickness of 2 mm, and was sliced into smaller sections with a dried spatula in an Ar-filled glovebox. The resulting sections were then carefully stacked in the Shigemi tube to retain a roughly cylindrical sample geometry.

A bipolar pulse pair, stimulated echo (BPP-STE), longitudinal eddy-current delay (LED) pulsed field gradient (PFG) experiment (D. H. Wu, A. D. Chen, C. S. Johnson, J. Magn. Reson. Ser. A 1995, 115 (2), 260-264) was used to measure signal attenuation due to diffusion in the sample plug. By dividing the total magnitude of the gradient pulse into two halves, of opposite sign and either side of a Th-pulse, large-amplitude gradient pulses can be supplied with eddy current ringdown largely cancelled (W. S. Price, NMR Studies of Translational Motion; 2009). Signal attenuation for a given diffusion rate is experimentally parameterized by the gradient magnitude g, the gradient duration δ, and the diffusion time Δ. The gradient encoding occurs on the transverse plane, so δ is ultimately limited by T₂, whereas in a STE PFG experiment, Δ occurs during a period of magnetization z-storage, and is therefore limited by T₁. T₁ is the spin-lattice relaxation time, and T₂ is the spin-spin relaxation time. For the materials wherein M=Ca, T₁ ranges from 111 to 138 ms, while T₂ is roughly an order of magnitude smaller, in the 10 to 20 ms range. Inversion recovery with a 3-second recycle delay was used to measure T₁, while T₂ was measured using CPMG with a 2 ms total echo delay. Accordingly, 5=2.4 ms was chosen for the gradient duration, and Δ=30 ms was used for the diffusion time (although at the coldest temperatures, for the slowest-diffusing phases, when the gradient strength was maximized, Δ was extended to maintain suitable attenuation). A 16-step gradient ramp ranging up to 2725 G/cm (or 99% of the probe capacity) was the primary variable for tracing out the signal attenuation at each temperature, with the ramp maximum set such that the last several points in the ramp achieved attenuation greater than 5% of the initial value, which enabled reliable fitting to the Stejskal-Tanner attenuation equation (E. O. Stejskal, J. E. Tanner, J. Chem. Phys. 1965, 42 (1), 288-292), with the necessary modifications for BPP-type experiments. The linearity of the gradient response—and therefore, the matching of the positive and negative gradients—was confirmed by repeating some experiments with g halved and δ commensurately increased, to maintain a fixed b=γ²g²δ²(Δ−δ/3−τ/2) value (with τ as the delay between the gradient and RF pulses; γis the nuclear gyromagnetic ratio). A recycle delay of 3.5 s, while significantly greater than 5 T₁, was imposed by the recommended duty cycle of the gradient coil. Additionally, a 143 G/cm, 2 ms spoiler gradient was applied during the z-storage diffusion time and the 5 ms LED time, in order to remove any residual transverse magnetization and permit a 16-step phase cycle per gradient step, which yielded ample SNR to perform the fitting.

3.2 Materials wherein M is Ca

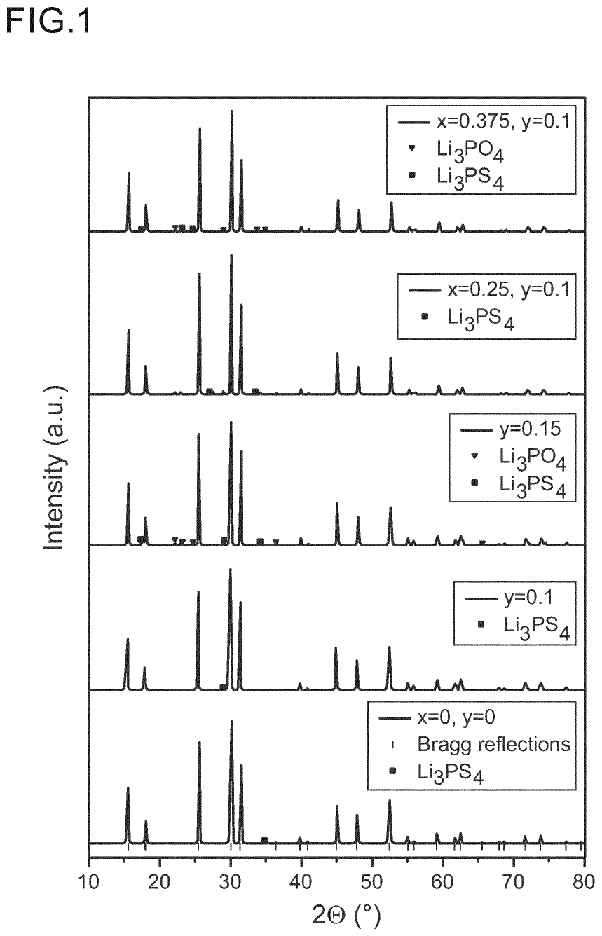

The XRD patterns for several solid materials of formula Li_{6+2*n-x-2*y}Ca_{y}PS₅₊ₙ₋ₓCl₁₊ₓ and of comparison material Li₆PS₅Cl are shown in FIGS. 1 to 4.

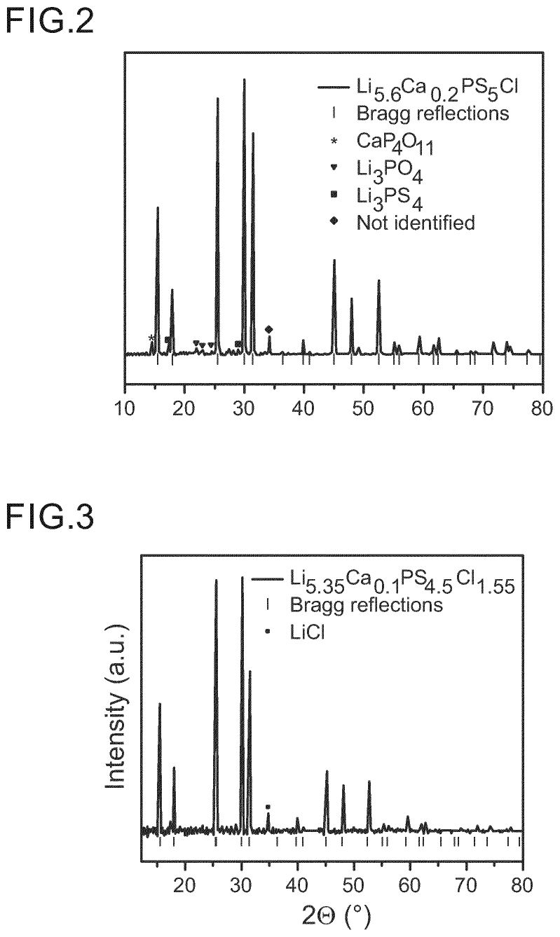

FIG. 1 shows XRD (capillary) patterns of several materials having a composition according to formula Li_{6-x-2y}Ca_{y}PS₅₋ₓCl₁₊ₓ (x=0 with y=0, 0.1, 0.15; x=0.25, y=0.1; x=0.375, y=0.1) representing the identified impurities. Vertical tick marks represent the calculated positions of the Bragg reflections for Li₆PS₅Cl (x=0, y=0). The materials wherein x=0 show a very small fraction of impurities (<2 wt %) which are not likely to impact the ionic conductivity. Efforts to synthesize a material wherein x=0 and y=0.2 led to the rise of Li₃PS₄ and CaP₄O₁₁ impurities (see FIG. 2 showing the XRD pattern of Li_{5.6}Ca_{0.2}PS₅Cl with impurity peaks marked) and a decrease in the ionic conductivity, indicating that when x=0 a limit of solid solubility may exist between y=0.15 and y=0.2.

For Li_{5.35}Ca₀₃₁PS_{4.5}Cl_{1.55} a small amount of LiCl impurity was observed (see FIG. 3 showing the XRD pattern of Li_{5.35}Ca_{0.1}PS_{4.5}Cl_{1.55} with the LiCl impurity peak marked). Vertical tick marks represent the calculated positions of the Bragg reflections.

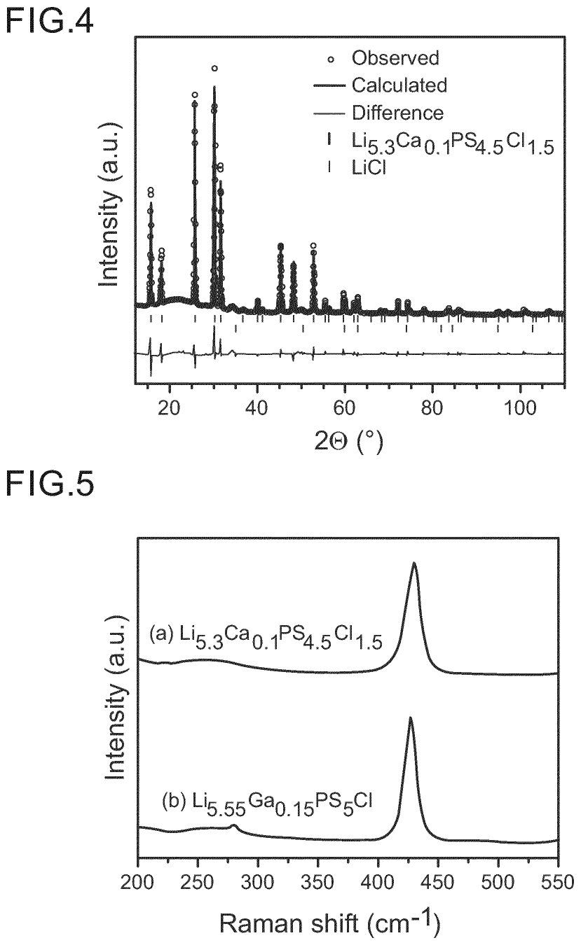

The materials having a composition according to formula Li_{6-x-2y}Ca_{y}PS₅₋ₓCl₁₊ₓ (x=0.25, y=0.1; x=0.375, y=0.1; x=0.5, y=0.1) are almost pure single phases (impurities <1.5 wt %), see the corresponding XRD patterns in FIG. 1 resp. in FIG. 4 (showing a Rietveld refinement of the XRD pattern of Li_{5.3}Ca_{0.1}PS_{4.5}Cl_{1.5}, GOF=1.51, Rwp=8.88, wherein GOF=goodness of fit; Rwp=R factor for weighted profile). In FIG. 4, circular markers correspond to the observed data points and a line shows the fit of the data points and the line close to the bottom is the difference map, the vertical tick marks in the upper row represent the calculated positions of the Bragg reflections of Li_{5.3}Ca_{0.1}PS_{4.5}Cl_{1.5}, and the vertical tick marks in the lower row represent the calculated positions of the Bragg reflections of LiCl.

The local structure of Li_{5.3}Ca_{0.1}PS_{4.5}Cl_{1.5} was explored with Raman spectroscopy, showing only the PS₄³⁻ moiety characteristic of the crystalline structure with no evidence of P₂S₆ (cf. FIG. 5(a) showing the Raman spectrum of Li_{5.3}Ca_{0.1}PS_{4.5}Cl_{1.5} with identified PS₄ moiety at 422 cm⁻¹). The EDX (for experimental details see below) analysis for Li_{5.3}Ca_{0.1}PS_{4.5}Cl_{1.5} yielded a Ca:P:Cl ratio of 0.10:1.00:1.48.

Further increase of the Ca content corresponding to a targeted composition (gross composition) Li_{5.45}Ca_{0.15}PS_{4.75}Cl_{1.25} led to the formation of a notable amount of secondary phases, which had an undesirable impact on the ionic conductivity. Apparently, the Cl-enriched argyrodites cannot sustain as high a degree of Ca substitution likely owing to the vacancy limitations on the 48h site.

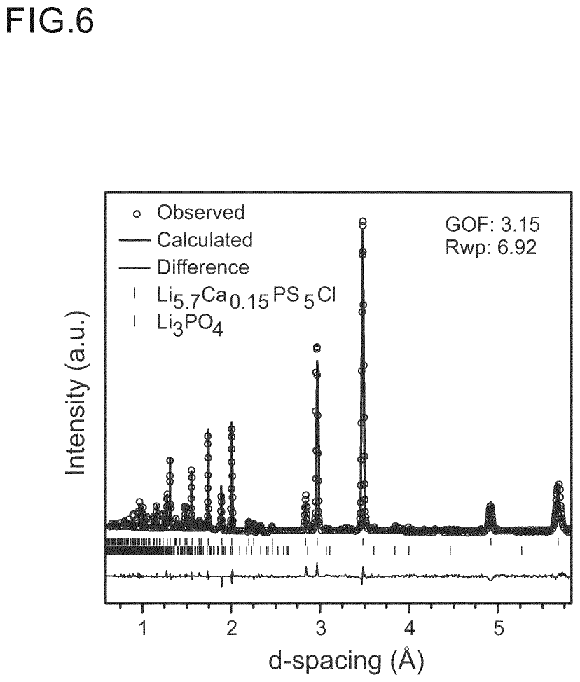

In order to get a better understanding of the structural influence of the presence of Ca²⁺ cations, Rietveld refinement against the time of flight (TOF) neutron diffraction pattern of Li_{5.7}Ca_{0.15}PS₅Cl (FIG. 6) was carried out in the cubic space group F4̅3m. In FIG. 6, circular markers correspond to the observed data points and a line shows the fit of the data points; the line close to the bottom is the difference map, the vertical tick marks in the upper row refer to Li_{5.7}Ca_{0.15}PS₅Cl, and the vertical tick marks in the lower row refer to Li₃PO₄.

The occupancies on the 4b and 16e sites were fixed at their stoichiometric values. The atomic coordinates and atomic displacement parameters (Uᵢₛₒ) were fixed to be the same for the shared sites S1 and Cl1 and for S2 and Cl2. The sum of occupancies was fixed at one for the shared sites (Occ(S1)+Occ(Cl1)=1 and Occ(S2)+Occ(Cl2)=1), and the atomic coordinates were fixed to be the same for Li and Ca on the 48h site. Because of the low Ca concentration, the Uᵢₛₒ for Ca (0.05 Å²) was fixed to be smaller than that of Li, assuming that a divalent cation will have a smaller atomic displacement parameter on the same site, due to its divalent nature and larger size. All parameters were subsequently refined. For both NPD refinements (Table 3 and Table 4), this assumption gave reasonable occupancy values that were in accordance with the targeted stoichiometry and EDX analysis (see below). Performing the refinement without fixing the Uᵢₛₒ for Ca²⁺ or with smaller fixed Uᵢₛₒ values, which was reported for Ca²⁺ substitution in other cubic thiophosphates, e.g. 0.04 Å², cf. C. K. Moon, H.-J. Lee, K. H. Park, H. Kwak, J. W. Heo, K. Choi, H. Yang, M.-S. Kim, S.-T. Hong, J. H. Lee, Y. S. Jung, ACS Energy Lett. 2018, 3, 2504), did not yield meaningful occupancies. The refinement results (Table 3) reveal that Li⁺ and Ca²⁺ ions both occupy the 48h site and neither are present on the 24g site in the argyrodite structure. The composition determined from the refinement is Li_{5.71}Ca_{0.15}PS_{4.95}Cl, which is very close to the targeted stoichiometry Li_{5.7}Ca_{0.15}PS₅Cl. The site disorder (ratio of Cl⁻/S²⁻ on the 4c site) is almost the same as in the parent phase Li₆PS₅Cl. The large atomic displacement parameter Uᵢₛₒ (0.084 Å²) refined for the 48h site is indicative of a fairly mobile Li ion at that position.

TABLE 3
Atomic coordinates, occupation factor and isotropic displacement
parameters of target composition Li_{5.7}Ca_{0.15}PS₅Cl obtained from
Rietveld refinement of neutron time of flight data (space group F4̅3m, a =
9.8414 (1) Å, and volume = 953.20 (2) Å³) yielding a refined composition
of Li_{5.71}Ca_{0.15}PS_{4.95}Cl.

| | Wyckoff | | | | | |
|---|---|---|---|---|---|---|
| Atom | Site | x | y | z | SOF | Uᵢₛₒ(Å²) |
| Li | 48 h | 0.3116 | 0.0234 | 0.6885 | 0.476(14) | 0.084(4) |
| Ca | 48 h | 0.3116 | 0.0234 | 0.6885 | 0.0125(30) | 0.05 |
| Cl1 | 4a | 0 | 0 | 0 | 0.420(9) | 0.024(1) |
| Cl2 | 4c | 1/4 | 1/4 | 1/4 | 0.628(11) | 0.033(1) |
| P1 | 4b | 0 | 0 | 0.5 | 1 | 0.025(1) |
| S1 | 4a | 0 | 0 | 0 | 0.580(9) | 0.024(1) |
| S2 | 4c | 1/4 | 1/4 | 1/4 | 0.372(11) | 0.033(1) |
| S3 | 16e | 0.1189 | −0.1189 | 0.6189 | 1 | 0.040(1) |

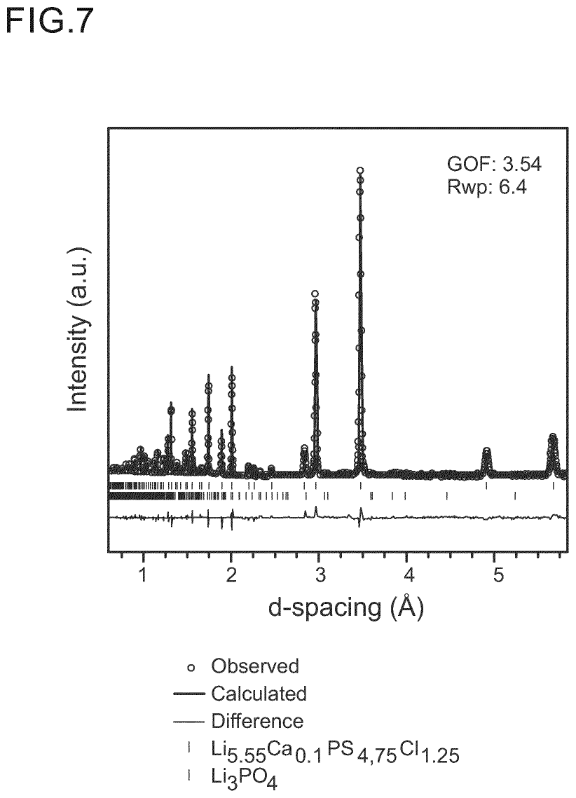

Rietveld refinement against the time of flight (TOF) neutron diffraction pattern of Li_{5.55}Ca_{0.1}PS_{4.75}Cl_{1.25} (FIG. 7) was carried out, where the Uᵢₛₒ values for Li and Ca on the 48h site were fixed, and the total occupancy on the 48h site was confined. All the parameters were subsequently refined. In FIG. 7, circular markers correspond to the observed data points and a line shows the fit of the data points; the line close to the bottom is the difference map, the vertical tick marks in the upper row refer to Li_{5.55}Ca_{0.1}PS_{4.75}Cl_{1.25} and the vertical tick marks in the lower to Li₃PO₄. The results of the Rietveld refinement are presented in Table 4 and show a refined composition of Li_{5.56}Ca_{0.10}PS_{4.73}Cl_{1.27} that is very close to the targeted stoichiometry Li_{5.55}Ca_{0.1}PS_{4.75}Cl_{1.25}. The site disorder increases to 74%, compared to 61% for Li₆PS₅Cl.

TABLE 4
Atomic coordinates, occupation factor and isotropic displacement parameters of
target composition Li_{5.55}Ca_{0.1}PS_{4.75}Cl_{1.25} obtained from Rietveld refinement of
neutron time of flight data (space group F4̅3m, a = 9.8222(1) Å, and volume = 947.59(2)
Å³) yielding a refined composition of Li_{5.56}Ca_{0.10}PS_{4.73}Cl_{1.27}

| | Wyckoff | | | | | |
|---|---|---|---|---|---|---|
| Atom | Site | x | y | z | SOF | Uᵢₛₒ(Å²) |
| Li | 48 h | 0.3143(15) | 0.0212(9) | 0.6858(15) | 0.463(3) | 0.075 |
| Ca | 48 h | 0.3143(15) | 0.0212(9) | 0.6858(15) | 0.008(3) | 0.05 |
| Cl1 | 4a | 0 | 0 | 0 | 0.536(15) | 0.028(1) |
| Cl2 | 4c | 1/4 | 1/4 | 1/4 | 0.738(15) | 0.033(1) |
| P1 | 4b | 0 | 0 | 0.5 | 1 | 0.030(1) |
| S1 | 4a | 0 | 0 | 0 | 0.464(15) | 0.028(1) |
| S2 | 4c | 1/4 | 1/4 | 1/4 | 0.262(15) | 0.033(1) |
| S3 | 16e | 0.120 | −0.120 | 0.620 | 1 | 0.049(1) |

For Li_{5.3}Ca_{0.1}PS_{4.5}Cl_{1.5}, Rietveld refinement (see table 5 and FIG. 4) was carried out against X-ray diffraction data (space group F4̅3m) using a=9.8132(1) ℄, and volume=945.02(4) Å³. Since X-rays are not able to resolve the Li occupancy, the occupancies for the 48h site were fixed to the nominal values and occupancies for the 4a site were fixed to the values obtained from NDP of Li_{5.5}PS_{4.5}Cl_{1.5}.

TABLE 5
Atomic coordinates, occupation factor and isotropic displacement parameters
of the targeted stoichiometry Li_{5.3}Ca_{0.1}PS_{4.5}Cl_{1.5} obtained from
Rietveld refinement against X-ray diffraction data (space group F4̅3m,
a = 9.8132(1) Å, and volume = 945.02(4) Å³).

| | Wyckoff | | | | | |
|---|---|---|---|---|---|---|
| Atom | Site | X | y | z | SOF | Uᵢₛₒ(Å²) |
| Li | 48 h | 0.329(1) | −0.001(2) | 0.671(1) | 0.440 | 0.114(9) |
| Ca | 48 h | 0.329(1) | −0.001(2) | 0.671(1) | 0.010 | 0.114(9) |
| Cl1 | 4a | 0 | 0 | 0 | 0.615 | 0.043(2) |
| S1 | 4a | 0 | 0 | 0 | 0.385 | 0.043(2) |
| Cl2 | 4c | 1/4 | 1/4 | 1/4 | 0.83(12) | 0.040(2) |
| S2 | 4c | 1/4 | 1/4 | 1/4 | 0.17(12) | 0.040(2) |
| P1 | 4b | 0 | 0 | 0.5 | 1 | 0.038(1) |
| S3 | 16e | 0.1211(2) | −0.1211(2) | 0.6211(2) | 1 | 0.063 |

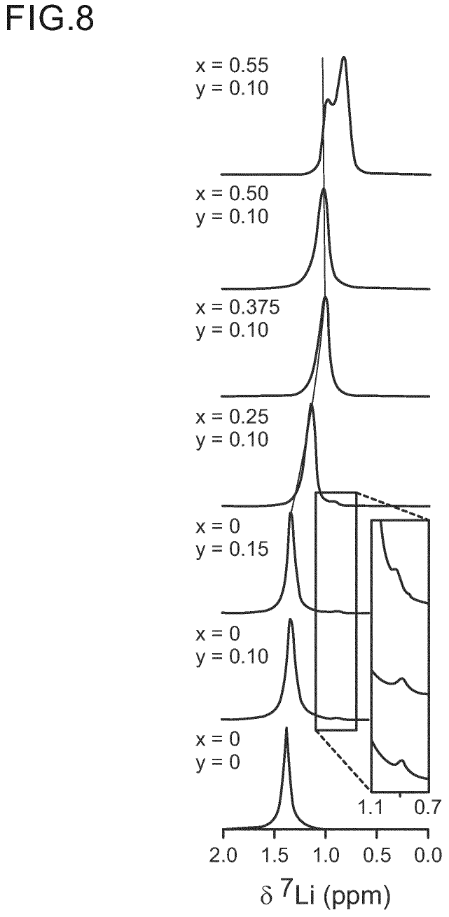

Along with the NPD studies, the presence of Ca²⁺ in the vicinity of Li⁺ was also established by the appearance of a small secondary peak in the ⁷Li MAS NMR measurements for several Ca²⁺-containing compositions along with the expected main resonance. FIG. 8 shows stack plots of ⁷Li MAS spectra which demonstrate a strong trend of the chemical shift with increasing chlorine content, while no major change in chemical shift is associated with Ca²⁺ doping when x=0. The inset in FIG. 8 reveals the secondary peak associated with the modification of the local electronic environment of a subset of the Li ions by the presence of Ca²⁺. Deconvolution of the lineshapes for Li_{5.8}Ca_{0.1}PS₅Cl, Li_{5.7}Ca_{0.15}PS₅Cl and Li_{5.55}Ca_{0.1}PS_{4.75}Cl_{1.25} for which the secondary peak was not obscured by the larger chemical shift trend caused by increasing chlorine content yielded peak areas with ratios corresponding to the Li⁺/Ca²⁺ stoichiometric ratio in each case. The secondary peak in the ⁷Li MAS NMR spectrum for Li_{5.55}Ca_{0.1}PS_{4.75}Cl_{1.25} is closer to the main resonance than it is for Li_{5.8}Ca_{0.1}PS₅Cl and Li_{5.7}Ca_{0.15}PS₅Cl, indicating a greater degree of averaging of the signals on the NMR timescale.

Additionally, ⁷Li 2D exchange spectroscopy (EXSY), while not quantitative in this case owing to the difficulty in deconvoluting overlapping spectral volumes, indicates that lithium species generating these secondary peaks are in close proximity to those producing the primary peaks that is, within the same phase, and not due to a contaminant impurity. This is because the cross peaks in an EXSY experiment can only form directly via chemical exchange or because of (short-range) homonuclear dipolar coupling (i.e. spin diffusion). The cross peaks in these EXSY spectra (not shown) indicate that the Li ions corresponding to the two peaks are more than likely undergoing chemical exchange given the short mixing times involved.

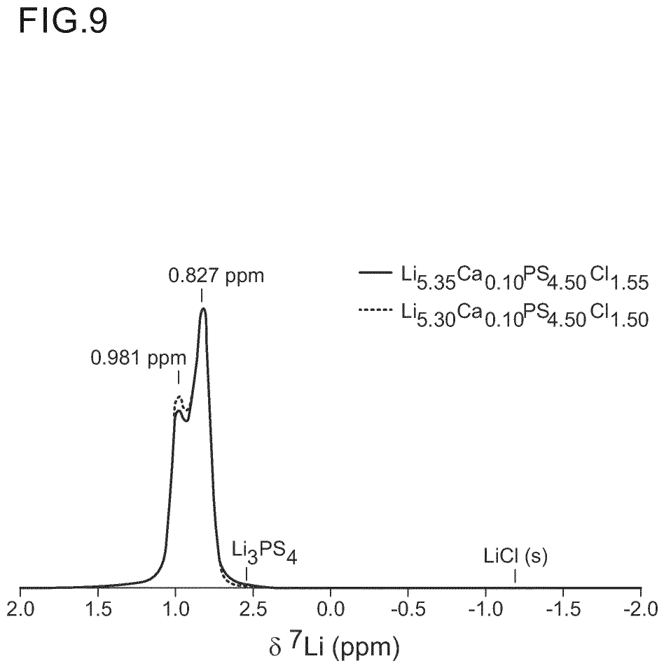

Different from the ⁷Li MAS spectrum shown in FIG. 8, certain samples having the targeted composition (gross composition) Li_{5.3}Ca_{0.1}PS_{4.5}Cl_{1.5} exhibited more than one main peak in the ⁷Li MAS NMR spectrum, although there was no indication of more than one main phase in the XRD pattern. When x is increased further (target composition Li_{5.35}Ca_{0.1}PS_{4.5}Cl_{1.55}) likely a mixture comprising the phase Li_{5.3}Ca_{0.1}PS_{4.5}Cl_{1.5} and another phase containing nanodomains where x>0.5 results. This is evidenced by the ⁷Li MAS NMR spectrum for the material having the target composition (gross composition) Li_{5.35}Ca_{0.1}PS_{4.5}Cl_{1.55}, which exhibits a peak at 0.98 ppm consistent with x=0.5 and an additional peak further shifted towards a more “LiCl-like” environment at 0.83 ppm. FIG. 9 shows the ⁷Li MAS NMR spectrum for Li_{5.35}Ca_{0.1}PS_{4.5}Cl_{1.55} at 20° C., 850 MHz field strength and 30 kHz MAS rate. The resonance at 0.98 ppm is consistent with x=0.5, as determined in a prior study W. S. Price, NMR Studies of Translational Motion; 2009) and consistent with the minimal modification of the chemical shift caused by Ca²⁺ relative to the significant modification of the chemical shift caused by Cl⁻ when x>0 (see FIG. 8), while the resonance at 0.83 ppm appears to be a much more halide-rich environment as per the established trend of the chemical shift by increased Cl⁻ substitution. The shown example of a sample having the target composition (gross composition) Li_{5.3}Ca_{0.1}PS_{4.5}Cl_{1.5} also exhibits the presence of two phases as it is the case for Li_{5.35}Ca_{0.1}PS_{4.5}Cl_{1.55}. There is negligible (<0.5% of integrated signal intensity) LiCl (s) in both samples.

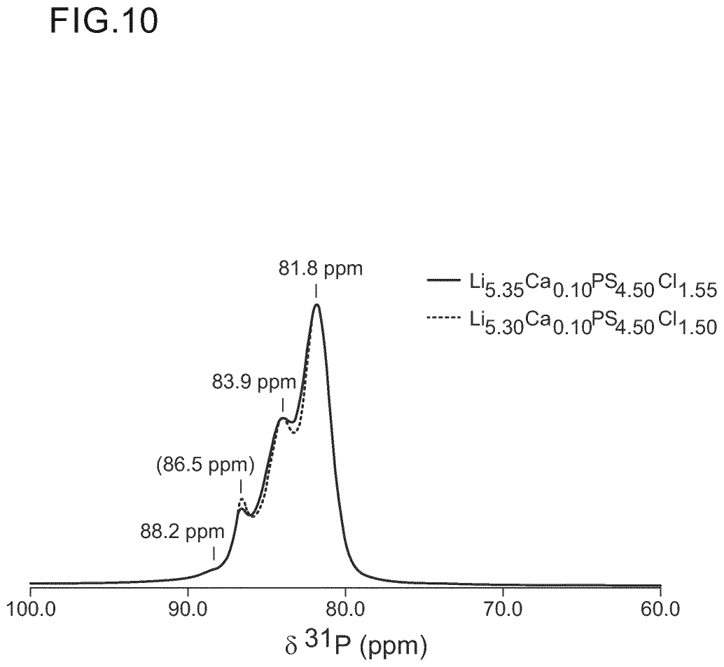

The ³¹P MAS NMR of a sample having the target composition Li_{5.35}Ca_{0.1}PS_{4.5}Cl_{1.55} exhibits a series of shifts with cascading intensities, indicative of progressively higher amounts of Cl⁻ substitution in the surrounding anion shells. FIG. 10 shows the ³¹P MAS NMR spectrum for Li_{5.35}Ca_{0.1}PS_{4.5}Cl_{1.55} at 20° C., 850 MHz field strength and 30 kHz MAS rate. The cascading pattern of nearly evenly-spaced resonances is indicative of a distribution of phosphorus environments with progressively increasing Cl⁻ substitution in the surrounding anion shells. The resonance at 86.5 ppm is indicative of isolated [PS₄]³⁻ tetrahedral moiety, and overlays the chemical shift distribution pattern (with the peak in this region expected, from the remainder of the pattern, to appear at 86 ppm). It potentially arises from a small amount of Li₃PS₄-like impurity, which would appear in the tail of the ⁷Li MAS spectrum at 0.5-0.6 ppm (see FIG. 9). Said Li₃PS₄-like impurity is also present in in the sample having the target composition (gross composition) provided Li_{5.3}Ca_{0.1}PS_{4.5}Cl_{1.5} shown for comparison in FIGS. 9 and 10.

3.3 Materials wherein M is Al or Ga

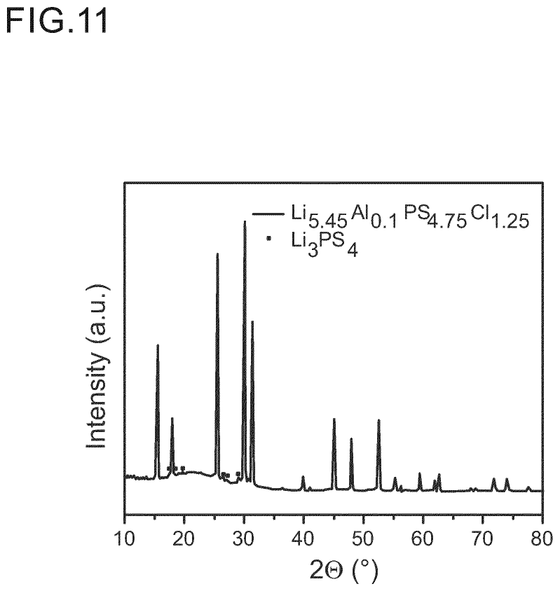

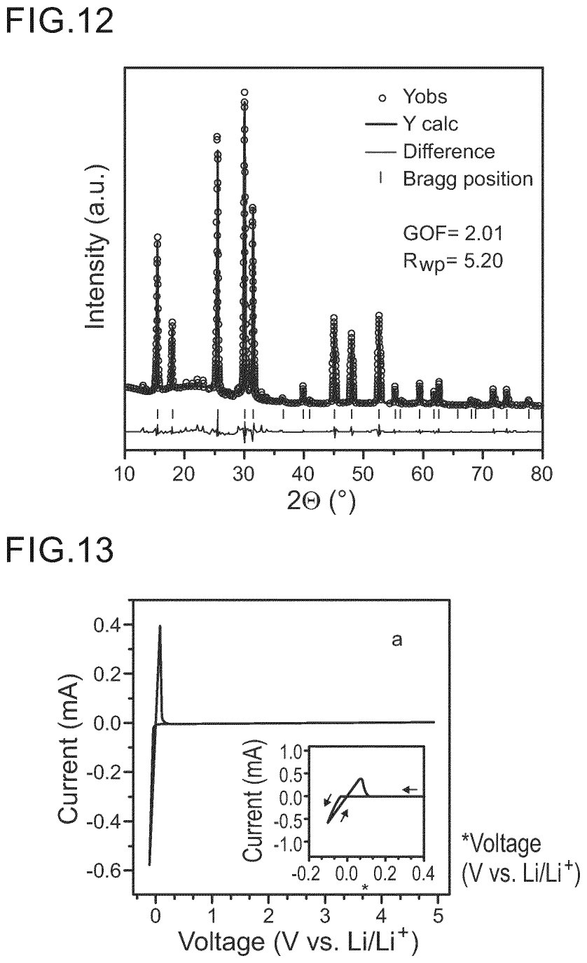

Owing to the smaller size of Al³⁺ (0.535 Å) and Ga³⁺ (0.620 Å) cations compared to Li⁺ (0.76 Å), only small fractions of Al resp. Ga could be incorporated (y=0.1) into the parent argyrodite structure Li₆PS₅Cl. An XRD pattern of Li_{5.45}Al_{0.1}PS_{4.75}Cl_{1.25} is shown in FIG. 11 with the Li₃PS₄ impurity peaks marked. An XRD pattern of Li_{5.7}Ga_{0.1}PS₅Cl with Rietveld refinement (a=9.8374(1) Å) obtained from whole pattern fitting is shown in FIG. 12, where circular markers correspond to the observed data points; and a line shows the fit of the data points; and the line close to the bottom is the difference map. Vertical tick marks indicate the calculated Bragg positions.

The local structure of Li_{5.55}Ga_{0.15}PS₅Cl was explored with Raman spectroscopy, showing only the PS₄³⁻ moiety characteristic of the crystalline structure with no evidence of P₂S₆ (cf. FIG. 5(b) showing the Raman spectrum of Li_{5.55}Ga_{0.15}PS₅Cl with identified PS₄³⁻ moiety at 422 cm⁻¹).

Attempts to synthesize phase pure Li_{6-3y}M_{y}PS₅Cl (M=A1 resp. Ga) wherein y>0.15 were unsuccessful and led to significant Li₃PS₄ and lithium thiogallate (LiGaS₂) impurities respectively.

4. Electrochemical Tests

The cyclic voltammogram of an all-solid-state cell having the configuration stainless steel (working electrode)|Li_{5.8}Ca_{0.1}PS₅Cl|Li(counter electrode) is shown in FIG. 13. The scan rate was 1 mV s⁻¹. It is evident that Li₅₃₈Ca_{0.1}PS₅Cl is stable against lithium metal within a broad potential window ranging from about 0.2 to 5 V vs Li/Li⁺. The redox process in the voltage range below 0.2 V vs Li/LC⁺ (see inset in FIG. 4) is attributed to the oxidation/reduction (Stripping/plating) of Li.

5. Correlation Between Structure and Ion Conductivity

Without wishing to be bound by any theory, it is assumed that the presence of anion disorder and of unoccupied neighboring sites for the mobile ion hops leads to increased lithium ion conductivity. The site disorder arises because Cl⁻ ions share two sites (4a and 4c) with S²⁻ which alters the energy landscape for Li ion diffusion. For Li_{6-2y}Ca_{y}PS₅Cl, the stepwise introduction of Ca in the Li site is accompanied by a gradual increase in vacancy concentration which is the main contributor to the enhancement in the ion conductivity, given that the disorder is not significantly changed vis a vis Li₆PS₅Cl. The effect of Ca²⁺ incorporation on the intracage or doublet jumps should be negligible at this small level of Ca²⁺ doping (one Ca per ˜10 and ˜6 cages for y=0.1, y=0.15 respectively) as it is the long-range transport between the cages (intercage) which dictates the macroscopic conductivity in Li-argyrodites, as demonstrated by ab initio molecular dynamics simulations. These studies showed that the intercage jump rate has the lowest jump frequency of all and will hence limit macroscopic diffusion. In the case of Li₆PS₅Cl, the jump rates are 0.73, 17.78, and 21.58 (×10¹⁰ s⁻¹) for intercage, intracage and doublet jumps, respectively [N. J. de Klerk, I. Rostoń, M. Wagemaker, Chem. Mater. 2016, 28, 7955]. The fact that Ca²⁺ does not disrupt transport is further supported by the activation energies of the Ca²⁺-substituted materials with x=0 (Table 1), which are effectively the same as Li₆PS₅Cl.

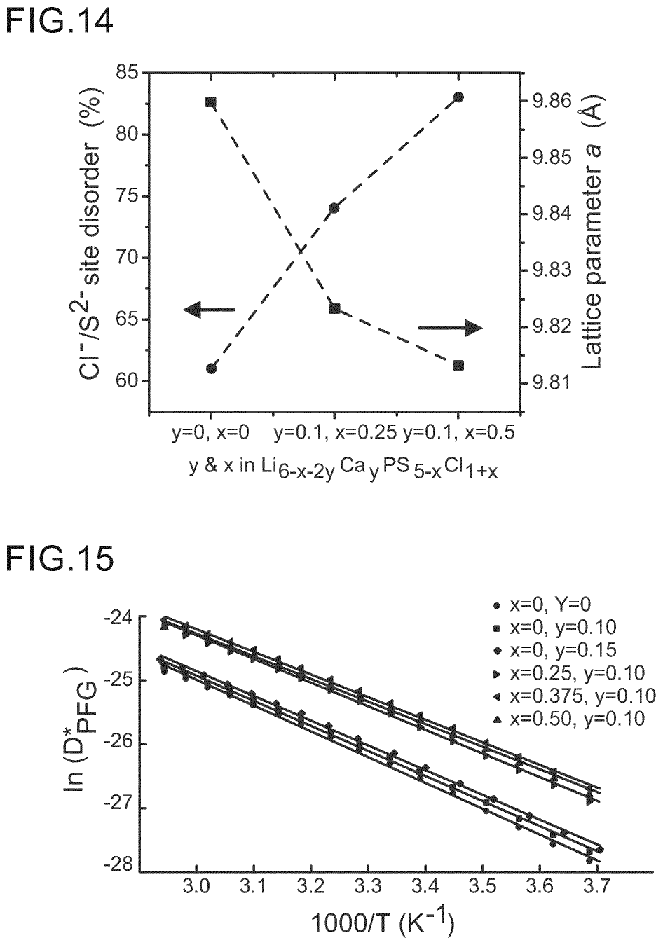

Introducing an aliovalent cation like Ca²⁺ into the argyrodite parent Li₆PS₅Cl structure creates Li vacancies and these generated vacancies increase the Li ion mobility and diffusivity as evident from impedance spectra recorded at different temperatures (not shown). Room temperature Li⁺ diffusivities of Li_{5.8}Ca_{0.1}PS₅Cl (y=0.1) and Li_{5.7}Ca_{0.15}PS₅Cl (y=0.15), resp., are 4.15*10⁻¹² m²/s and 4.44*10⁻¹² m²/s respectively, compared with 3.85*10⁻¹² m²/s for Li₆PS₅Cl (parent structure, y=0), which reflects a respective 8% and 15% increase. Li_{5.3}Ca_{0.1}PS_{4.5}Cl_{1.5} exhibits a high diffusivity of 9.1*10⁻¹² m²/s, which is about 2.5 times that of the parent composition Li₆PS₅Cl, but lower than that of the Cl-enriched composition Li_{5.5}PS_{4.5}Cl_{1.5} (P. Adeli, J. D. Bazak, K. H. Park, I. Kochetkov, A. Huq, G. R. Goward, L. F. Nazar, Angew. Chem. Int. Ed. 2019, 58, 8681; Angew. Chem. 2019, 131, 8773). In contrast, Li_{5.35}Ca_{0.1}PS_{4.5}Cl_{1.55} has remarkably high diffusivity of 1.21*10⁻¹¹ m²/s which is 33% higher than the diffusivity of Li_{5.3}Ca_{0.1}PS_{4.5}Cl_{1.5}. Thus, in Li_{6-x-2y}Ca_{y}PS₅₋ₓCl₁₊ₓ, simultaneous substitution of Li⁺ cation and S²⁻ anion yields additional vacancies that contract the lattice to result in a progressive decrease in the intercage hop distance with the chlorine content, along with an increase in the site disorder (see FIG. 14 showing the site disorder Cl⁻/S²⁻ and the lattice parameter a vs. x and y for Li_{6-x-2y}Ca_{y}PS₅₋ₓCl₁₊ₓ). These factors, conjointly with the weakened electrostatic interactions between the mobile Li⁺-ions and surrounding framework anions (induced by substitution of divalent S²⁻ for monovalent Cl), apparently are key contributors to the high ionic conductivities for the compositions wherein x>0 (Cl-enriched), similar to what was found for the Cl-enriched argyrodites derived from Li₆PS₅Cl (P. Adeli, J. D. Bazak, K. H. Park, I. Kochetkov, A. Huq, G. R. Goward, L. F. Nazar, Angew. Chem. Int. Ed. 2019, 58, 8681; Angew.Chem.

For each composition wherein y>0, the chemical shift was virtually identical to that of the Cl-enriched argyrodites derived from Li₆PS₅Cl which do not contain a metal M as further substituent which were previously studied (P. Adeli, J. D. Bazak, K. H. Park, I. Kochetkov, A. Huq, G. R. Goward, L. F. Nazar, Angew. Chem. Int. Ed. 2019, 58, 8681; Angew.Chem. 2019, 131, 8773). Combined with the relatively small ⁷Li chemical shift of the materials having a composition according to formula Li_{6-2y}Ca_{y}PS₅Cl (x=0) relative to the parent material Li₆PS₅Cl (see FIG. 8), this suggests that the Ca²⁺ cations do not significantly modify the electronic environment of Li⁺ within the cages where the Ca²⁺ cations reside; their primary contribution to improving the transport is the introduction of excess vacancies to the Li⁺ cage network.

Activation energy is a factor that governs ionic conductivity. For the materials wherein M is Ca, the lowest activation energy is exhibited by the material having the target composition Li_{5.35}Ca_{0.1}PS_{4.5}Cl_{1.55} (0.30 eV, cf. table 1 above). Activation energy values obtained from ⁷Li PFG-NMR are in good accord with the values obtained from impedance spectroscopy, as compared in Table 1. FIG. 15 shows a comparison of PFG-NMR Arrhenius plots for the series of Ca-containing compositions with x=0 and with x>0. Even within the restricted temperature range 268 K-343 K (from which the activation energies in Table 1 were calculated) there is still a slight curvature in the Arrhenius plots.

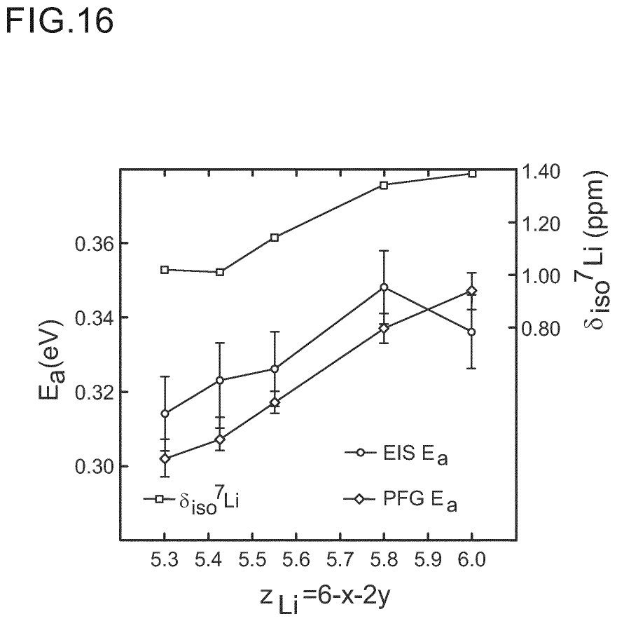

FIG. 16 shows a correlation of activation energies from both electrochemical impedance spectroscopy (EIS) and PFG-NMR, as well as of the ⁷Li isotropic chemical shift, with lithium stoichiometry z_{Li}=6−x−2y. Increasing x lowers the ⁷Li chemical shift toward a more ionic, “LiCl-like” environment, but this effect eventually saturates, indicating that there is a limit to which disordering of S²⁻ sites with Cl⁻ can decrease Li⁺ attraction to the anion framework. The activation energy continues decreasing as x is increased, which stems from the impact of the additional vacancies on Li⁺ sites. Conversely, the lack of a decrease of chemical shift when y changes from y=0 to y=0.1 opposes the associated activation energy drop, which can therefore be attributed strictly to the increased vacancy population. FIG. 16 also demonstrates that the most significant lowering of the activation energy can be achieved by moderate Cl⁻ enrichment with a small amount of Ca²⁺ doping. The two effects act in concert to both lower the activation energy and boost the magnitudes of the conductivity and diffusivity to a greater amount than performing one or the other, when the solubility limit of the lattice with respect to either dopant (Ca²⁺ and Cl⁻) is not exceeded. Ionic conductivities of the materials according to the first aspect described above resp. obtained by the process according to the second aspect described above can be further improved by hot pressing, cold-pressing or sintering the powder, so that the grain boundaries are modified. The effect of purely cold-pressing is discussed now in further detail.

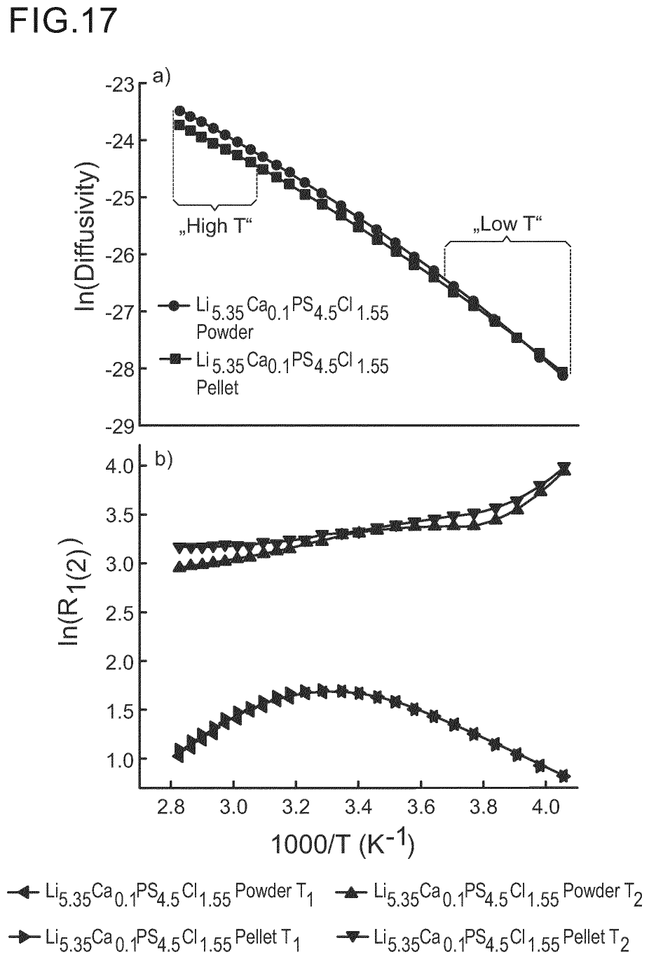

Further insight into the magnitude of the activation energy changes was obtained by performing ⁷Li PFG-NMR on both a powder sample and a pressed pellet sample of the material having the target composition Li_{5.35}Ca_{0.1}PS_{4.5}Cl_{1.55}. FIG. 17 shows a) a diffusivity Arrhenius plot from variable-temperature ⁷Li PFG-NMR measurements on powder and pellet-pressed samples of Li_{5.35}Ca_{0.1}PS_{4.5}Cl_{1.55} exhibiting non-ideal Arrhenius behaviour with a cross-over in slopes from low to high temperature which is significantly reduced in the pellet sample, and b) NMR relaxation rates of the powder and pellet samples. Regarding FIG. 17b), Ti is the spin-lattice relaxation time, and T₂ is the spin-spin relaxation time. Two inflection points are present in the T₂ curves, indicating the presence of two distinct motional correlation times. Over the temperature range of 243 K to 358 K, the Arrhenius plots exhibit non-ideal behaviour, with curvature appearing in the lower temperature region of this range.

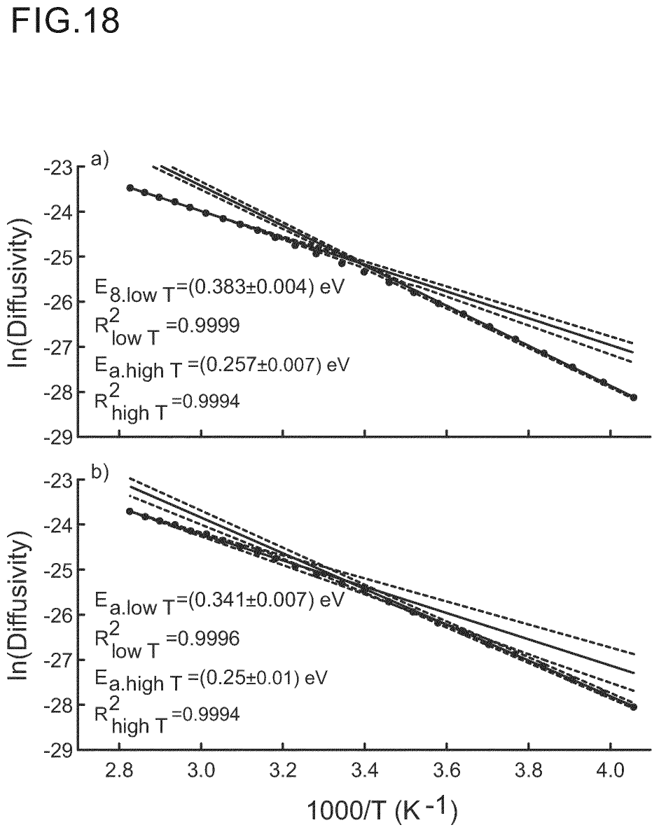

FIG. 18 shows the two-component activation energy fits to the Arrhenius plots for the ⁷Li PFG NMR data for the powder (a) and pellet (b) versions of Li_{5.35}Ca_{0.1}PS_{4.5}Cl_{1.55}. The non-ideal Arrhenius behaviour appears to be indicative of competing grain contributions and grain-boundary contributions to the overall lithium-ion transport, with the latter having greater influence at lower temperature. The grain boundary influence is reduced by the compression of the sample into a pellet. The activation energy obtained by performing a two-component, limiting-slope fit of the PFG-NMR Arrhenius plots (FIG. 17) is (0.257±0.007) eV to (0.383±0.004) eV for the powder sample of Li_{5.35}Ca_{0.1}PS_{4.5}Cl_{1.55}.

A conclusion from comparing the activation energies between the powder and pellet-pressed samples is that in the “high temperature” regime (as defined by the range of temperatures fit to the upper limiting slope) governed by the grain contribution, the Arrhenius slopes are essentially parallel. On the other hand, in the “low temperature” regime, there is a distinct reduction in slope between the pellet-pressed and powder samples, which can be attributed to a reduction in the difficulty of hops over grain dislocations in pelletized samples when the spatial extent of these gaps is presumably reduced by the macroscopic compression of the sample.

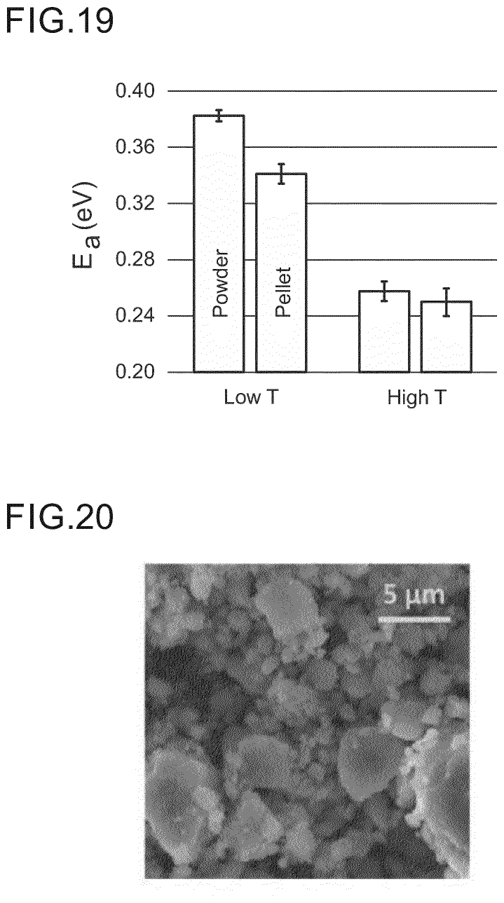

FIG. 19 shows a comparison of powder and pellet activation energies in the “low-temperature”- and “high-temperature” regions of the ⁷Li PFG-NMR diffusivity Arrhenius plots from FIG. 17a for the sample having the target composition Li_{5.35}Ca_{0.1}Cl_{1.55}. In the high temperature region, the activation energy of the powder and pellet samples does not differ significantly, and is associated with grain contributions. The compression to form the pellet enhances transport across grain dislocations in multi-crystallite particles, which is the source of the lower activation energy in the pellet sample for the low-temperature region, since the low temperature region is associated with grain boundary contributions.

For all-solid-state batteries employing thiophosphates, it is desirable to employ the electrolyte in the form of cold-pressed pellets so that a sintering treatment may be avoided. Hence it is important that a solid electrolyte exhibits high conductivity in the absence of sintering. The material Li_{5.35}Ca_{0.1}PS_{4.5}Cl_{1.55} possesses a high room temperature ionic conductivity of 10.2 mS cm⁻¹ in the cold-pressed state with a low activation energy of 0.30±0.01 eV and a very high diffusivity of 1.21×10⁻¹¹ m²/s.

6. Scanning Electron Microscopy (SEM) and Energy Dispersive X-ray Analysis (EDX)

Energy dispersive X-ray (EDX) analysis results provided elemental ratios that were in very good accord with the target values. A Zeiss Leo 1530 FESEM (with EDX detector) was utilized for microstructural observation of the samples as well as elemental analysis. As the materials were not stable under prolonged electron beam illumination, an acceleration voltage of 15 kV, with an acquisition time of 1 minute was used for EDX measurements. The results are given in tables 6 and 7 below.

TABLE 6
EDX analysis of Li_{5.8}Ca_{0.1}PS₅Cl, Li_{5.7}Ca_{0.15}PS₅Cl
and Li_{5.3}Ca_{0.1}PS_{4.5}Cl_{1.5}. Given the slight amount of
hydrolysis that takes place during the material transfer into the
SEM chamber, the sulfur content could not be accurately quantified.
A minimum of 4 measurements per composition is reported.

| | Li_{5.8}Ca_{0.1}PS₅Cl | | | | | |
|---|---|---|---|---|---|---|
| | Atomic percent | | | Weight percent | | |
| Measurement | Ca | P | Cl | Ca | P | Cl |
| M1 | 1.79 | 16.01 | 17.70 | 2.20 | 15.20 | 19.23 |
| M2 | 1.83 | 16.02 | 18.04 | 2.25 | 15.20 | 19.59 |
| M3 | 1.67 | 17.38 | 15.42 | 2.06 | 16.55 | 16.81 |
| M4 | 1.89 | 17.10 | 16.47 | 2.33 | 16.25 | 17.91 |
| M5 | 1.60 | 17.87 | 15.84 | 1.97 | 17.01 | 17.26 |
| Average | 1.76 | 16.88 | 16.69 | 2.16 | 16.04 | 18.16 |
| Standard dev. | 0.11 | 0.74 | 1.15 | | | |
| Normalized to Cl content | 0.10 | 1.01 | 1.00 | | | |
| | Li_{5.7}Ca_{0.15}PS₅Cl | | | | | |
| | Atomic percent | | | Weight percent | | |
| Measurement | Ca | P | Cl | Ca | P | Cl |
| M1 | 3.14 | 16.09 | 18.30 | 3.84 | 15.21 | 19.80 |
| M2 | 3.12 | 15.45 | 18.26 | 3.82 | 14.60 | 19.76 |
| M3 | 2.15 | 17.48 | 15.09 | 2.64 | 16.63 | 16.43 |
| M4 | 2.49 | 16.28 | 14.63 | 3.07 | 15.48 | 15.92 |
| Average | 2.73 | 16.33 | 16.57 | 3.34 | 15.48 | 17.98 |
| Standard dev. | 0.42 | 0.73 | 1.70 | | | |
| Normalized to Cl content | 0.16 | 0.99 | 1.00 | | | |
| | Li_{5.3}Ca_{0.1}PS_{4.5}Cl_{1.5} | | | | | |
| | Atomic percent | | | Weight percent | | |
| Measurement | Ca | P | Cl | Ca | P | Cl |
| M1 | 1.26 | 15.39 | 21.55 | 1.55 | 14.56 | 23.35 |
| M2 | 1.52 | 15.61 | 22.27 | 1.87 | 14.75 | 24.10 |
| M3 | 1.52 | 14.2 | 23.72 | 1.86 | 13.40 | 25.61 |
| M4 | 1.6 | 15.13 | 22.62 | 1.96 | 14.29 | 24.45 |
| M5 | 1.45 | 15.53 | 22.27 | 1.78 | 14.68 | 24.10 |
| Average | 1.47 | 15.17 | 22.49 | 1.80 | 14.34 | 24.32 |
| Standard dev. | 0.01 | 0.26 | 0.5 | | | |
| Normalized to P content | 0.10 | 1.00 | 1.48 | | | |

TABLE 7
EDX analysis of the Li_{5.7}Ga_{0.1}PS₅Cl and Li_{5.45}Al_{0.1}PS_{4.75}Cl_{1.25}.
Given the slight amount of hydrolysis that takes place
during the material transfer into the SEM chamber,
the sulfur content could not be accurately quantified.
A minimum of three measurements per composition are reported.

| | Li_{5.8}Ga_{0.1}PS₅Cl | | | | | |
|---|---|---|---|---|---|---|
| | Atomic percent | | | Weight percent | | |
| Measurement | Ga | P | Cl | Ga | P | Cl |
| M1 | 1.73 | 15.95 | 16.34 | 3.64 | 14.93 | 17.50 |
| M2 | 1.71 | 17.15 | 14.26 | 3.61 | 16.10 | 15.31 |
| M3 | 1.10 | 17.42 | 14.66 | 2.33 | 16.46 | 15.85 |
| M4 | 1.50 | 15.87 | 17.05 | 3.17 | 14.88 | 18.30 |
| Average | 1.51 | 16.60 | 15.58 | 3.19 | 15.59 | 16.74 |
| Standard dev. | 0.25 | 0.69 | 1.15 | | | |
| Normalized to Cl content | 0.10 | 1.06 | 1.00 | | | |

| | Li_{5.45}Al_{0.1}PS_{4.75}Cl_{1.25} | | | | | |
|---|---|---|---|---|---|---|
| | Atomic percent | | | Weight percent | | |
| Measurement | Al | P | Cl | Al | P | Cl |
| M1 | 1.24 | 16.57 | 19.48 | 1.03 | 15.81 | 21.26 |
| M2 | 1.43 | 16.48 | 19.42 | 1.19 | 15.72 | 21.21 |
| M3 | 1.39 | 16.50 | 19.46 | 1.15 | 15.74 | 21.24 |
| Average | 1.35 | 16.52 | 19.45 | 1.12 | 15.76 | 21.24 |
| Standard dev. | 0.08 | 0.04 | 0.02 | | | |
| Normalized | 0.09 | 1.10 | 1.25 | | | |

The morphology of the microcrystalline material Li_{5.8}Ca_{0.1}PS₅Cl was studied by scanning electron microscopy. FIG. 20 reveals that there is a distribution in the size of the particles, which is predominantly between 0.5 to 5 μm.

1. A solid material having a composition according to general formula (I)
Li_{6+2*n-x-m*y}M_{y}PS_{5+nb-x}X₁₊ₓ (I)
wherein
M is one or more selected from the group consisting of divalent metals Mg, Ca, Sr, Ba and Zn, and trivalent metals Sc, La, Al and Ga;
X is one or more selected from the group consisting of F, Cl, Br and I;
0≤x≤0.8;
0.01≤y≤0.25;
0≤n≤0.05;
m is 2 when M is a divalent metal and m is 3 when M is a trivalent metal wherein the solid material comprises a crystalline phase having the argyrodite structure.

2. The solid material according to claim 1, wherein in general formula (I)
M is one or more selected from the group consisting of Mg, Ca, Sr, Ba and Zn;
0.01≤y≤0.2;
and m is 2.

3. The solid material according to claim 2 wherein M is Ca and X is Cl.

4. The solid material according to claim 1, wherein in general formula (I)
M is one or more selected from the group consisting of Sc, La, Al and Ga;
0.01≤y≤0.15;
m is 3
and n=0.

5. The solid material according to claim 4 wherein M is Al or Ga, and X is Cl.

6. The solid material according to claim 1, wherein
for the molar ratio X/P=a, the following condition is satisfied: 1.45≤a≤1.6 and/or
for the molar ratio M/P=c, the following condition is satisfied: 0.01≤c≤0.15.

7. The solid material according to claim 6, wherein for the molar ratio X/M=a/c, the following condition is satisfied: 15.30≤a/c≤15.55.

8. A process for preparing a solid material according to claim 1, the process comprising:
a) preparing or providing a reaction mixture comprising the precursors
(1) Li₂S,
and/or
Li and S in elemental form
(2) one or more sulfides of phosphorus
(3) one or more compounds LiX wherein X is selected from the group consisting of F, Cl, Br and I
(4) one or more sulfides of metals M selected from the group consisting of divalent metals Mg, Ca, Sr, Ba and Zn, and trivalent metals Sc, La, Al and Ga
and/or
S in elemental form and one or more metals M selected from the group consisting of divalent metals Mg, Ca, Sr, Ba and Zn, and trivalent metals Sc, La, Al and Ga
(5) optionally one or more halides MXₘ wherein X is selected from the group consisting of F, Cl, Br and I; M is selected from the group consisting of divalent metals Mg, Ca, Sr, Ba and Zn, and trivalent metals Sc, La, Al and Ga;
and m is 2 when M is a divalent metal and m is 3 when M is a trivalent metal
wherein in the reaction mixture the molar ratio of the elements Li, M, P, S and X matches general formula (I);
b) heat-treating the reaction mixture in a temperature range of from 500° C. to 800° C. for a total duration of from 3 hours to 350 hours so that a reaction product is formed, and cooling the obtained reaction product so that a solid material having a composition according to general formula (I) is obtained.

9. The process according to claim 8, wherein the reaction mixture is obtained by grinding together the precursors so that a powder is obtained, and optionally pressing the powder into pellets.

10. The process according to claim 8 wherein the precursors are
(1) Li₂S
(2) P₂S₅
(3) LiCl
(4) one or more compounds selected from CaS, Al₂S₃ and Ga₂S₃.

11. (canceled)

12. A solid structure for an electrochemical cell, wherein [[said]]the solid structure is selected from the group consisting of cathode, anode and separator, wherein [[said]]the solid structure comprises a solid material according to claim 1.

13. An electrochemical cell comprising a solid material according to claim 1.

14. An electrochemical cell according to claim 13, wherein the solid material is a component of a solid structure as defined in claim 1.
